(19) United States
(12) Patent Application Publication
(10) Pub. No.: US 2021/0269666 A1
(43) Pub. Date: Sep. 2, 2021

(54) ACTINIC ENERGY RAY-CURABLE COMPOSITION, AND CURED FILM AND ANTIREFLECTION FILM THEREOF

(71) Applicant: DIC Corporation, Tokyo (JP)

(72) Inventors: Miki Ota, Ichihara-shi (JP); Ryosuke Hashide, Ichihara-shi (JP); Kazuki Obi, Ichihara-shi (JP); Nobuyuki Koike, Ichihara-shi (JP); Kenji Sakai, Hakusan-shi (JP)

(73) Assignee: DIC Corporation, Tokyo (JP)

(21) Appl. No.: 17/261,244

(22) PCT Filed: Jun. 25, 2019
(86) PCT No.: PCT/JP2019/025068

§ 371 Date: Jan. 19, 2021

(30) Foreign Application Priority Data
Jul. 19, 2018 (JP) 2018-135859
Feb. 21, 2019 (JP) 2019-029439

(51) Int. Cl. C09D 155/00; C09D 7/61; C09D 5/00; C08F 290/12

(52) U.S. Cl. CPC C09D 155/00; C08F 290/12; C09D 5/006; C09D 7/61

(57) ABSTRACT

An actinic energy ray-curable composition contains a low-refractive-index material capable of dissolving in a general-purpose solvent and that can impart excellent scratch resistance to a surface of its cured coating film, and a cured film and an antireflection film thereof. An actinic energy ray-curable composition contains a poly(perfluoroalkylene ether) chain-containing actinic energy ray-curable polyfunctional compound (I) and an actinic energy ray-curable compound (II) that is a copolymer of polymerizable unsaturated monomers, the actinic energy ray-curable compound (II) having a side chain containing a fluorinated alkyl group (x) having 1 to 6 carbon atoms to which a fluorine atom is attached and a side chain containing an actinic energy ray-curable group (y), the actinic energy ray-curable compound (II) having a silicone chain (z) with a molecular weight of 2,000 or more at one end of the copolymer, and a cured film and an antireflection film obtained by curing the composition.

### TECHNICAL FIELD

The present invention relates to an actinic energy ray-curable composition and an antireflective coating composition from which a coating film having excellent scratch resistance is formed and a cured film and an antireflection film formed by using them.

### BACKGROUND ART

A functional layer having antiglare properties and antireflection properties is provided on the outermost surface of a polarizing plate, which is one of the members constituting a liquid crystal display. The functional layer is required to have scratch resistance in addition to the antiglare properties and the antireflection properties for improving visibility.

For example, in the case where a low-reflection (LR) layer is disposed to provide antireflection properties, it is important for all the constituent materials to have a low refractive index in order to exhibit performance. However, low index materials typically have poor scratch resistance. Additionally, the LR layer has a thickness of about 100 nm and thus is susceptible to damage from scratches. To address this problem, it has been reported that a fluorine-containing polymerizable resin having a perfluoropolyether chain, a silicone group, and a polymerizable unsaturated group is added to a coating composition for the LR layer to impart sliding properties to a surface of the LR layer and improve scratch resistance (for example, Patent Literature 1).

### CITATION LIST

### Patent Literature

PTL 1: Japanese Unexamined Patent Application Publication No. 2013-181039

### SUMMARY OF INVENTION

### Technical Problem

An antireflective coating composition containing the fluorine-containing polymerizable resin described in Patent Literature 1 is, to some extent, effective in improving the scratch resistance. A poly(perfluoroalkylene ether) chain is disposed in the central portion of a compound as a molecular design in order to maintain compatibility with a non-fluorine-based actinic energy ray-curable compound. This affects the shape of the poly(perfluoroalkylene ether) chain at a surface of a coating film to make it difficult to sufficiently exhibit performance inherent in the perfluoroalkylene ether chain. A structural problem of the disposition of the polymerizable unsaturated group via a structure originating from another monomer causes a high proportion of a non-fluorinated moiety in the compound, thereby limiting an increase in the density of fluorine atoms present at the outermost surface of the cured coating film.

In recent years, a trend toward higher-definition displays has required antireflection films having lower reflectance. To reduce the reflectance, it is necessary to reduce the refractive index of a material constituting such an antireflection layer. To reduce the refractive index of the antireflection layer, for example, a method for increasing the fluorine component content of the material constituting the layer is conceivable. The material having high fluorine content, however, has poor solubility in a general-purpose solvent; thus, a fluorine-containing solvent needs to be used for the preparation of a coating liquid. When such a coating material is used, special solvent recovery equipment is required, which is a practical problem.

In light of the foregoing circumstances, objects of the present invention are to provide an actinic energy ray-curable composition that contains a low-refractive-index material capable of dissolving in a general-purpose solvent and that can impart excellent scratch resistance to a surface of a cured coating film thereof, and a cured film and an antireflection film thereof.

### Solution to Problem

The inventors have conducted intensive studies to solve the foregoing problems and have found the following: in the case of using an actinic energy ray-curable composition containing a poly(perfluoroalkylene ether) chain-containing actinic energy ray-curable polyfunctional compound (I) and an actinic energy ray-curable compound (II) that is a copolymer of polymerizable unsaturated monomers, the actinic energy ray-curable compound (II) having a side chain containing a fluorinated alkyl group (x) having 1 to 6 carbon atoms to which a fluorine atom is attached and a side chain containing a polymerizable unsaturated group (y), the actinic energy ray-curable compound (II) having a silicone chain (z) with a molecular weight of 2,000 or more at one end of the copolymer, it is possible to provide, for example, high-density arrangement of fluorine atoms at the outermost surface of a cured product, even the arrangement of the silicone chain at the surface, a significant improvement in scratch resistance, satisfactory solubility in a fluorine atom-free actinic energy ray-curable compound and a general-purpose solvent, and excellent appearance of a cured film to be obtained.

That is, the present invention provides an actinic energy ray-curable composition containing a poly(perfluoroalkylene ether) chain-containing actinic energy ray-curable polyfunctional compound (I), and an actinic energy ray-curable compound (II) that is a copolymer of polymerizable unsaturated monomers, the actinic energy ray-curable compound (II) having a side chain containing a fluorinated alkyl group (x) having 1 to 6 carbon atoms to which a fluorine atom is attached and a side chain containing an actinic energy ray-curable group (y), the actinic energy ray-curable compound (II) having a silicone chain (z) with a molecular weight of 2,000 or more at one end of the copolymer; and a cured film and an antireflection film obtained by curing the composition.

### Advantageous Effects of Invention

When the composition of the present invention is applied to a substrate, the composition enables an increase in the density of fluorine atoms segregated at a surface by the action of minimizing the surface free energy, which is peculiar to fluorine atoms, and the impartation of significant scratch resistance to the outermost surface of the cured film by the appropriate disposition of the silicone chain in a coating film. The composition of the present invention contains a structural unit for sufficient compatibility with non-fluorinated compounds and enables the cured film to have a reflectance of 1% or less without impairing the appearance of the cured film, which is extremely useful, for example, for an antireflection film provided at the outermost surface of a liquid crystal display.

### DESCRIPTION OF EMBODIMENTS

An actinic energy ray-curable composition of the present invention is characterized by containing a poly(perfluoroalkylene ether) chain-containing actinic energy ray-curable polyfunctional compound (I) and an actinic energy ray-curable compound (II) that is a copolymer of polymerizable unsaturated monomers, the actinic energy ray-curable compound (II) having a side chain containing a fluorinated alkyl group (x) having 1 to 6 carbon atoms to which a fluorine atom is attached and a side chain containing a polymerizable unsaturated group (y), the actinic energy ray-curable compound (II) having a silicone chain (z) with a molecular weight of 2,000 or more at one end of the copolymer.

The combination of the polyfunctional compound (I) and the compound (II) results in the presence of many fluorine atoms at a surface of a cured film, so that the cured film has a low refractive index and can have high scratch resistance because of the arrangement of the silicone chain having appropriate molecular length in the vicinity of the surface. Additionally, both compounds are cured with actinic energy rays and have excellent performance durability because the positions of both compounds present in the cured film are fixed. The composition sufficiently contains non-fluorinated moieties and thus can maintain compatibility with a non-fluorinated compound, so that the resulting cured film has satisfactory appearance even in a system also containing a non-fluorinated compound.

The poly(perfluoroalkylene ether) chain-containing actinic energy ray-curable polyfunctional compound (I) is not particularly limited as long as it is a compound having a poly(perfluoroalkylene ether) chain and multiple actinic energy ray-curable groups in one molecule. From the viewpoint of the ease of imparting high scratch resistance and its durability to the resulting cured film and from the viewpoint of the curability of the composition, the compound preferably has one or more (meth)acryloyl groups at each end of a molecular chain containing the poly(perfluoroalkylene ether) chain.

In the present invention, the term “(meth)acrylate” refers to one or both of methacrylate and acrylate. The term “(meth)acryloyl group” refers to one or both of a methacryloyl group and an acryloyl group. The term “(meth)acrylic acid” refers to one or both of methacrylic acid and acrylic acid.

An example of the poly(perfluoroalkylene ether) chain (hereinafter, referred to as a “PFPE chain”) is a chain having a structure in which divalent fluorocarbon groups having 1 to 3 carbon atoms and oxygen atoms are alternately linked. The divalent fluorocarbon groups having 1 to 3 carbon atoms may be of one type or a combination of different types. Specific examples thereof include structures represented by structural formula 1 below:

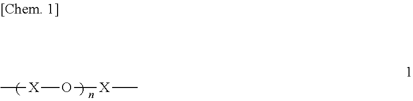

(wherein in structural formula 1, X groups are represented by structural formulae a to f, all X groups in structural formula 1 may have the same structure, multiple structures may be present randomly or in blocks, and n is a number greater than or equal to 1 representing a repeating unit).

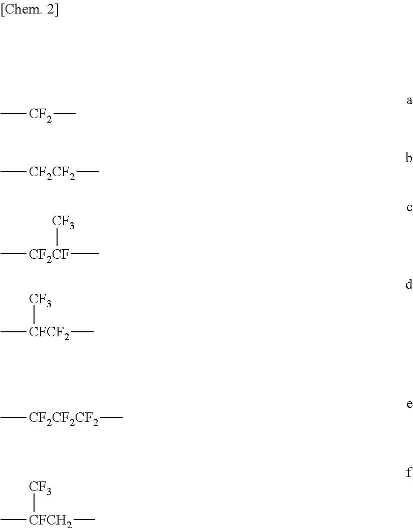

Among these, especially from the viewpoint of achieving better scratch resistance of the resulting cured film, a structure including both of the perfluoromethylene structure represented by structural formula a and the perfluoroethylene structure represented by structural formula b is particularly preferred. The ratio by mole of the perfluoromethylene structure represented by structural formula a to the perfluoroethylene structure represented by structural formula b present (structure a/structure b) is more preferably 1/4 to 4/1 in view of scratch resistance. The value of n in structural formula 1 is preferably in the range of 3 to 40, particularly preferably 6 to 30.

Regarding the PFPE chain, the total number of fluorine atoms contained in one PFPE chain is preferably in the range of 18 to 200, particularly preferably 25 to 80 from the viewpoint of easily improving compatibility with a non-fluorinated actinic energy ray-curable compound. The PFPE chain preferably has a weight-average molecular weight (Mw) of 400 to 10,000, more preferably 500 to 5,000.

The number-average molecular weight (Mn) and the weight-average molecular weight (Mw) are values measured by gel permeation chromatography (hereinafter, abbreviated as “GPC”) in terms of polystyrene. The measurement conditions of GPC are described below.

### [GPC Measurement Condition]

Measurement device: “HLC-8220 GPC”, available from Tosoh Corp.
Column: Tosoh Corp. “HHR-H” guard column (6.0 mm I.D.×4 cm)+Tosoh Corp. “TSK-GEL GMHHR-N” (7.8 mm I.D.×30 cm)+Tosoh Corp. “TSK-GEL GMHHR-N” (7.8 mm I.D.×30 cm)+Tosoh Corp. “TSK-GEL GMHHR-N” (7.8 mm I.D.×30 cm)+Tosoh Corp. “TSK-GEL GMHHR-N” (7.8 mm I.D.×30 cm)
Detector: ELSD (Alltech “ELSD 2000”)
Data processing: “GPC-8020 Model II, data analysis version 4.30”, available from Tosoh Corp.
Measurement conditions: Column temperature: 40° C.
   Eluent: tetrahydrofuran (THF)
   Flow rate: 1.0 ml/min
Sample: a solution (100 μ1) obtained by filtering a 1.0% by mass tetrahydrofuran solution in terms of resin solid content through a microfilter
Standard sample: monodisperse polystyrenes having known molecular weights were used in accordance with the measurement manual of “GPC-8020 Model II, data analysis version 4.30”.

### (Monodisperse Polystyrene)

“A-500”, available from Tosoh Corp.
“A-1000”, available from Tosoh Corp.
“A-2500”, available from Tosoh Corp.
“A-5000”, available from Tosoh Corp.
“F-1”, available from Tosoh Corp.
“F-2”, available from Tosoh Corp.
“F-4”, available from Tosoh Corp.
“F-10”, available from Tosoh Corp.
“F-20”, available from Tosoh Corp.
“F-40”, available from Tosoh Corp.
“F-80”, available from Tosoh Corp.
“F-128”, available from Tosoh Corp.
“F-288”, available from Tosoh Corp.
“F-550”, available from Tosoh Corp.

As the actinic energy ray-curable group of the poly(perfluoroalkylene ether) chain-containing actinic energy ray-curable polyfunctional compound (I), the following functional groups can be exemplified.

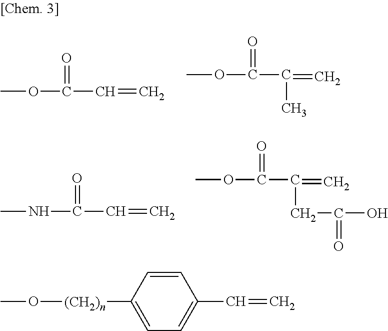

Among these, an acryloyloxy group or a methacryloyloxy group is preferred from the viewpoint of great versatility and excellent curability in the form of a composition.

As the compound that has a molecular chain containing the poly(perfluoroalkylene ether) chain and that has one or more (meth)acryloyl groups at each end of the molecular chain, the following compounds are exemplified. The expression “-PFPE-” in each structural formula below refers to the foregoing PFPE chain.

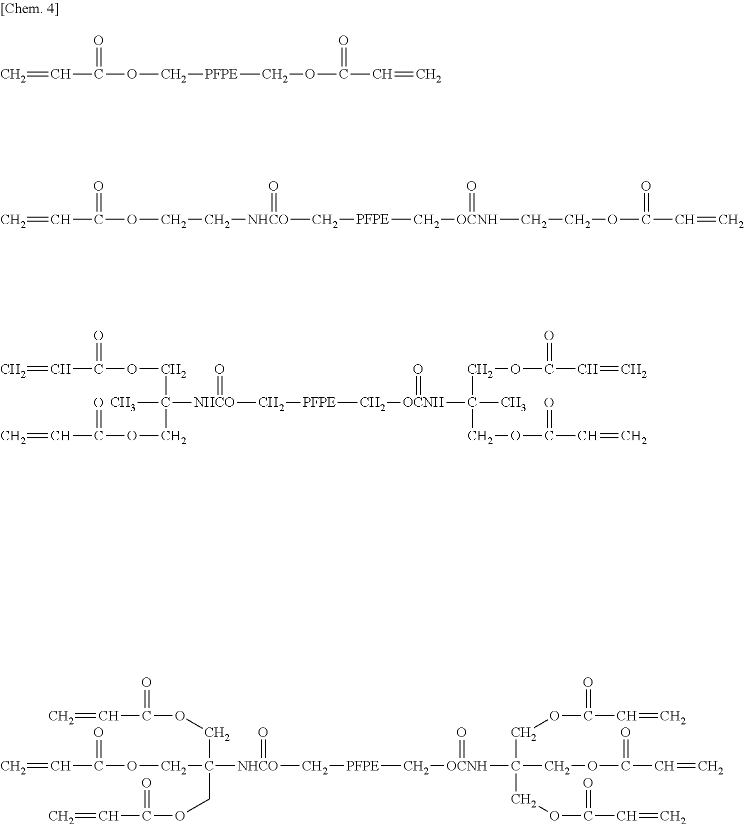

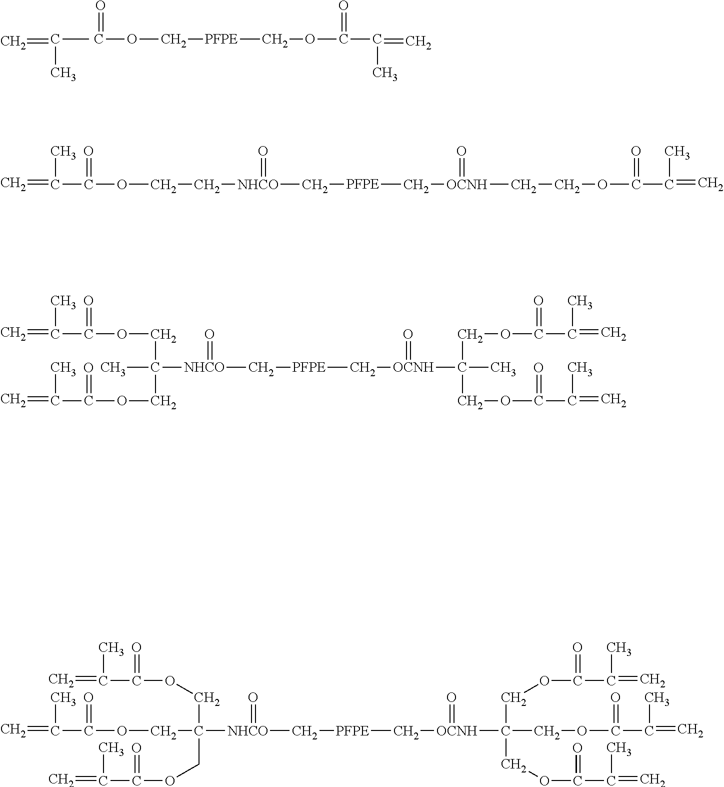

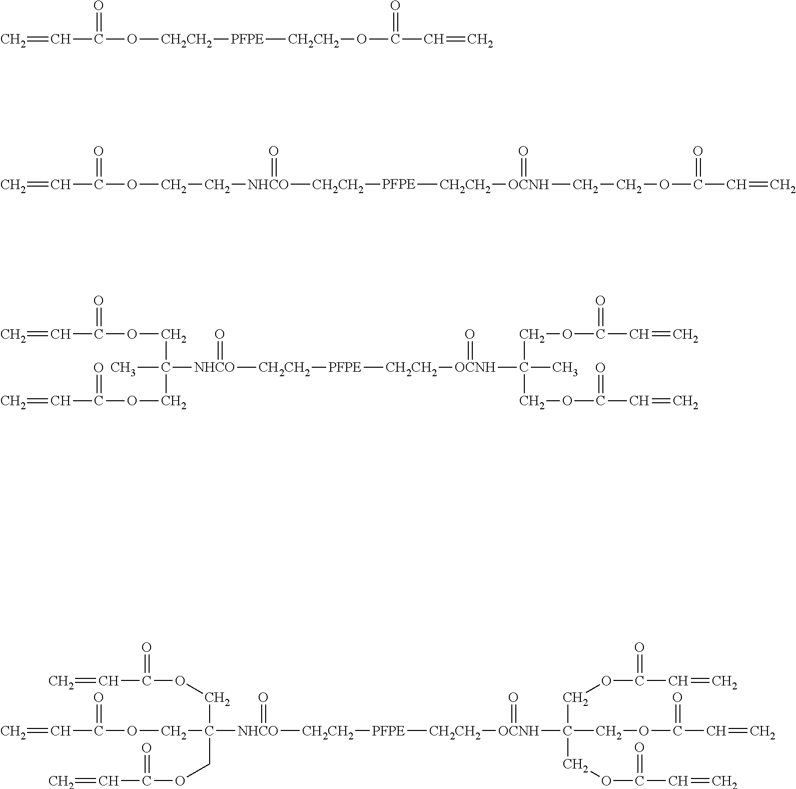

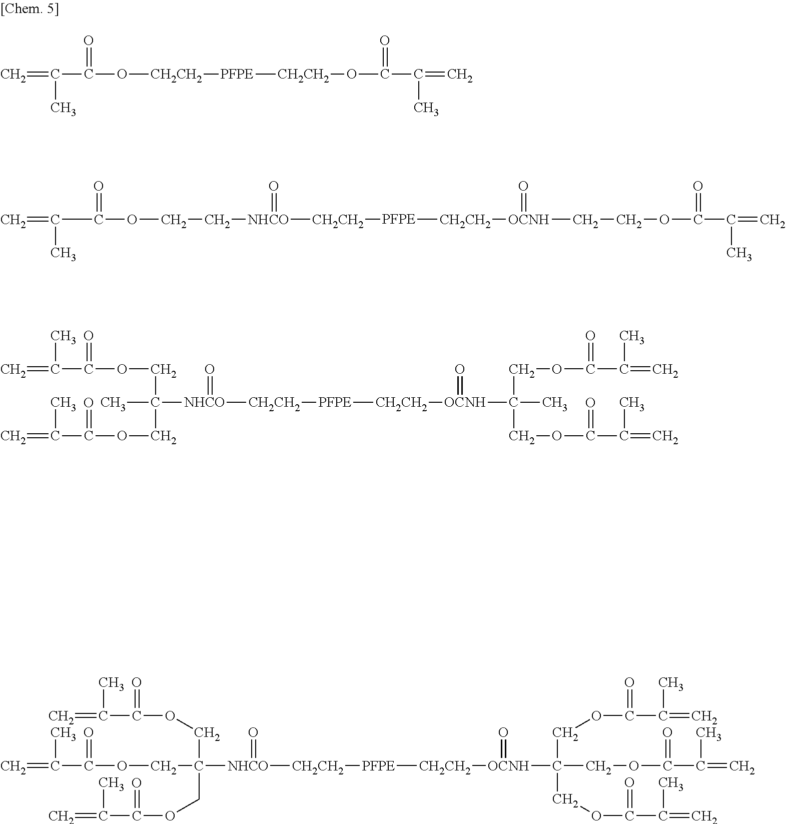

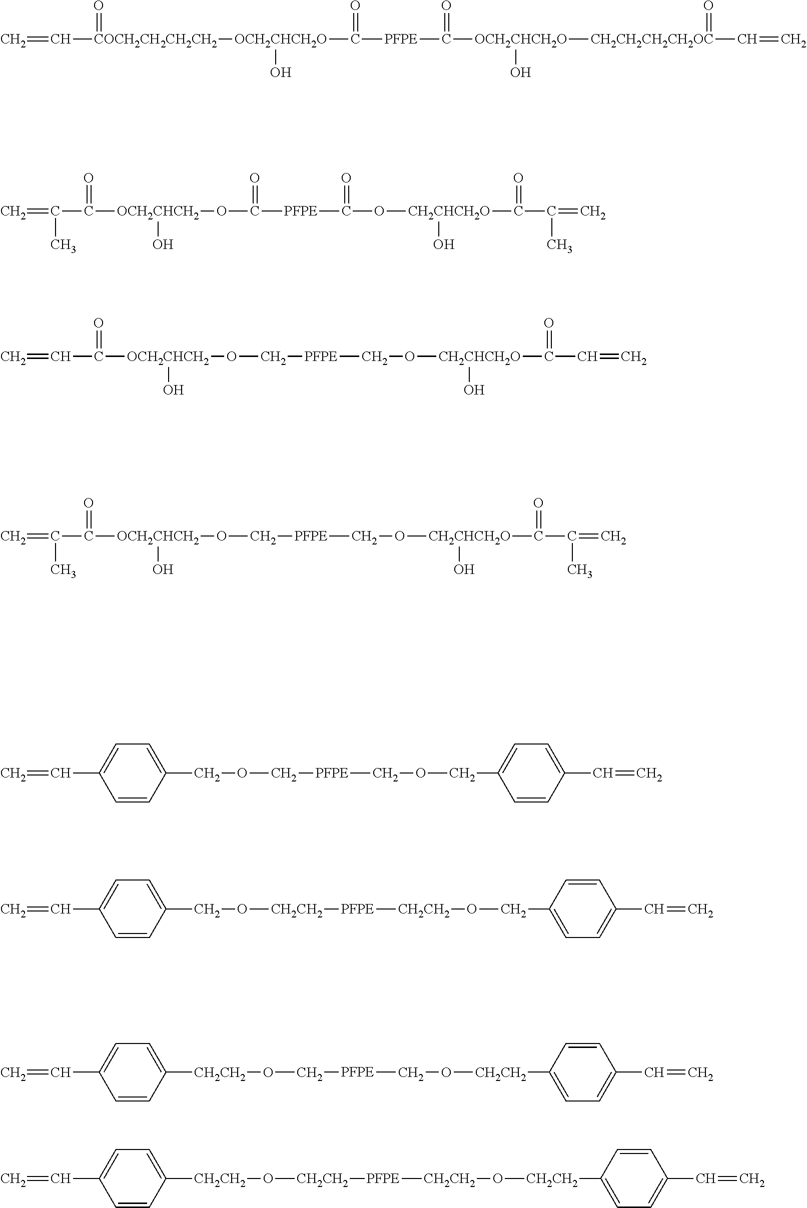

Examples of a method for producing the PFPE chain-containing compound having a (meth)acryloyl group include a method in which a compound containing a PFPE chain having a hydroxy group at its end undergoes a reaction with acrylic acid chloride, a dehydration reaction with acrylic acid, a urethane-forming reaction with 2-acryloyloxyethyl isocyanate, a urethane-forming reaction with 1,1-(bisacryloyloxymethyl)ethyl isocyanate, or an esterification reaction with itaconic anhydride, a method in which a compound containing a PFPE chain having a carboxy group at its end undergoes an esterification reaction with 4-hydroxybutyl acrylate glycidyl ether, a method in which a compound containing a PFPE chain having an isocyanate group at its end is allowed to react with 2-hydroxyethylacrylamide, and a method in which a compound containing a PFPE chain having an epoxy group is allowed to react with acrylic acid.

Among these, the method in which a compound containing a PFPE chain having a hydroxy group at its end undergoes a reaction with (meth)acrylic acid chloride or a urethane-forming reaction with 2-acryloyloxyethyl isocyanate or 1,1-(bisacryloyloxymethyl) ethyl isocyanate is particularly preferred because of its ease of reaction in production. The details of the production method can be found in, for example, Japanese Unexamined Patent Application Publication No. 2017-134271, and the syntheses can be performed by known reaction methods.

Examples of the compound containing a PFPE chain having a hydroxy group at its end include Fomblin D2, Fluorolink D4000, Fluorolink E10H, 5158X, and 5147X, and Fomblin Z-tet-raol, available from Solvay Specialty Polymers; and Demnum-SA, available from Daikin Industries, Ltd. Examples of the compound containing a PFPE chain having a carboxy group at its end include Fomblin ZDIZAC4000, available from Solvay Specialty Polymers; and Demnum-SH, available from Daikin Industries, Ltd. “Fomblin” is a registered trademark of Solvay Specialty Polymers. “Fluorolink” is a registered trademark of Solvay. “Demnum” is a registered trademark of Daikin Industries, Ltd.

As the compound that has a molecular chain containing the poly(perfluoroalkylene ether) chain and that has one or more (meth)acryloyl groups at each end of the molecular chain, for example, MFPE-26, MFPE-34, or MFPE-331, available from Unimatec Co., Ltd., may be used as it is.

Among these, a compound that has a molecular chain containing the poly(perfluoroalkylene ether) chain and that has two or more (meth)acryloyl groups at each end of the molecular chain via a urethane linkage is preferably used from the viewpoint of achieving satisfactory curability when it is combined with the actinic energy ray-curable compound (II) that is a copolymer of polymerizable unsaturated monomers, that has a side chain containing a fluorinated alkyl group (x) having 1 to 6 carbon atoms to which a fluorine atom is attached and a side chain containing an actinic energy ray-curable group (y), and that has a silicone chain (z) with a molecular weight of 2,000 or more at one end of the copolymer described below, and from the viewpoint of further improving the scratch resistance of a cured film to be formed.

Additionally, a compound that has a molecular chain containing the poly(perfluoroalkylene ether) chain and that has a (meth)acryloyl group at each end of the molecular chain via a structure originating from styrene is preferably used from the viewpoint of achieving satisfactory curability when it is combined with the actinic energy ray-curable compound (II) that is a copolymer of polymerizable unsaturated monomers, that has side chains with a fluorinated alkyl group (x) having 1 to 6 carbon atoms to which a fluorine atom is attached and an actinic energy ray-curable group (y), and that has a silicone chain (z) with a molecular weight of 2,000 or more at one end of the copolymer described below, and from the viewpoint of further improving the scratch resistance of a cured film to be formed.

The present invention is characterized by using the polyfunctional compound (I) in combination with the actinic energy ray-curable compound (II) that is a copolymer of polymerizable unsaturated monomers, that has a side chain containing a fluorinated alkyl group (x) having 1 to 6 carbon atoms to which a fluorine atom is attached and a side chain containing an actinic energy ray-curable group (y), and that has a silicone chain (z) with a molecular weight of 2,000 or more at one end of the copolymer.

The actinic energy ray-curable compound (II) has a structure including a main chain formed by the polymerization of a polymerizable unsaturated monomer, the main chain being composed of a polymerizable resin having a side chain containing a fluorinated alkyl group (x) having 1 to 6 carbon atoms to which a fluorine atom is attached and a side chain containing a polymerizable unsaturated group (y), and a silicone chain having a molecular weight of 2,000 or more at one end of the main chain. One or more silicone chains may be present at the one end. In the present invention, the main chain preferably has a single (one) silicone chain at one end thereof in view of the scratch resistance and the surface segregation of fluorine atoms of a cured film to be formed.

The fluorinated alkyl group (x) preferably has 4 to 6 carbon atoms, more preferably 6 carbon atoms because of a satisfactory balance between surface segregation properties and scratch resistance.

The equivalent weight of the polymerizable unsaturated group (y) in the compound (II) is preferably in the range of 200 to 3,500 g/eq., more preferably 250 to 2,000 g/eq., even more preferably 300 to 1,500 g/eq., particularly preferably 400 to 1,000 g/eq. because a cured film having further improved scratch resistance is obtained.

The silicone chain is required to have a molecular weight of 2,000 or more. The compound containing the silicone chain having the molecular weight can appropriately express the slidability of the silicone chain; thus excellent scratch resistance can be imparted by reducing friction on a surface of the cured film. The molecular weight of the silicon chain is preferably in the range of 2,000 to 20,000, more preferably 5,000 to 10,000.

The compound (II) can be obtained in various forms by changing the timing of the polymerization of the raw materials. For example, when a polymerizable unsaturated monomer (B) having a fluorinated alkyl group with 1 to 6 carbon atoms to which a fluorine atom is attached and a polymerizable unsaturated monomer (C) having a reactive functional group (c1), which will be described below, are simultaneously added to a reaction system and reacted, the resulting compound is in the form of what is called a random copolymer. When the polymerizable unsaturated monomer (B) and the polymerizable unsaturated monomer (C) are separately reacted, the resulting compound is in the form of what is called a block copolymer. In particular, a block copolymer is preferred because excellent scratch resistance can be provided even when a very thin coating film having a thickness of about 0.1 μm is formed from the actinic energy ray-curable composition of the present invention.

For example, the compound (II) in the form of a random copolymer can be obtained from a compound (A) having a functional group with an ability to generate a radical at one end of a silicone chain having a molecular weight of 2,000 or more, the polymerizable unsaturated monomer (B) having a fluorinated alkyl group with 1 to 6 carbon atoms to which a fluorine atom is attached, the polymerizable unsaturated monomer (C) having a reactive functional group (c1), and a compound (D) having a functional group (d1) reactive with the functional group (c1) and a polymerizable unsaturated group (d2). Specifically, the compound (II) is obtained by copolymerizing the polymerizable unsaturated monomer (B) with the polymerizable unsaturated monomer (C) using radicals generated from the compound (A) and then allowing the resulting copolymer (P) to react with the compound (D).

In the case where the compound (II) is in the form of a block polymer, an example thereof is a compound having a structure including a first polymer segment (a) having a main chain formed by the polymerization of a polymerizable unsaturated monomer and a side chain of the main chain, the side chain containing the fluorinated alkyl group (x) having 1 to 6 carbon atoms to which a fluorine atom is attached; a second polymer segment (β) having a main chain formed by the polymerization of a polymerizable unsaturated monomer and a side chain of the main chain, the side chain containing the polymerizable unsaturated group (y); and a silicone chain having a molecular weight of 2,000 or more at one end.

The compound in the form of a block polymer can be preferably produced by a production method described below.
Method 1: A production method includes a step (1) of feeding a compound (A) having a functional group with an ability to generate a radical at one end of a silicone chain with a molecular weight of 2,000 or more and a polymerizable unsaturated monomer (B) having a fluorinated alkyl group (x) with 1 to 6 carbon atoms to which a fluorine atom is attached into a reaction system and allowing the compound (A) to generate a radical to produce a polymer segment (p) including a structure originating from the polymerizable unsaturated monomer (B);

a step (2) of feeding a polymerizable unsaturated monomer (C) having a reactive functional group (c1) into the reaction system containing the polymer segment (p) and allowing the polymer segment (p) to generate a radical to produce a polymer (Q1) containing the polymer segment (p) and a polymer segment (q) including a structure originating from the polymerizable unsaturated monomer (C); and

a step of (3) of feeding a compound (D) having a functional group (d1) reactive with the functional group (c1) of the polymer (Q1) and a polymerizable unsaturated group (d2) into the reaction system containing the polymer (Q1) to allow the reactive functional group (c1) to react with the reactive functional group (d1).
Method 2: A production method including a step (1-1) of feeding a compound (A) having a functional group with an ability to generate a radical at one end of a silicone chain with a molecular weight of 2,000 or more and a polymerizable unsaturated monomer (C) having a reactive functional group (c1) into a reaction system and allowing the compound (A) to generate a radical to produce a polymer segment (q) including a structure originating from the polymerizable unsaturated monomer (C);

a step (2-1) of feeding a polymerizable unsaturated monomer (B) into the reaction system containing the polymer segment (q) and allowing the polymer segment (q) to generate a radical to produce a polymer (Q2) containing the polymer segment (q) and a polymer segment including a structure originating from the polymerizable unsaturated monomer (B); and

a step (3-1) of feeding a compound (D) having a functional group (d1) reactive with the functional group (c1) of the polymer (Q2) and a polymerizable unsaturated group (d2) into the reaction system containing the polymer (Q2) to allow the reactive functional group (c1) to react with the reactive functional group (d1).

Examples of the functional group, having an ability to generate a radical, of the compound (A) include halogen atom-containing organic groups, alkyltellurium group-containing organic groups, dithioester group-containing organic groups, peroxide group-containing organic groups, and azo group-containing organic groups. In the case where the polymerizable unsaturated monomer (B) and the polymerizable unsaturated monomer (C) are copolymerized with the compound (A) by living radical polymerization, a halogen atom-containing organic group, an alkyltellurium group-containing organic group, or a dithioester group-containing organic group can be used as the functional group having an ability to generate a radical. In particular, a halogen atom-containing organic group is preferably used because of the ease of synthesis, the ease of polymerization control, and the variety of polymerizable unsaturated monomers that can be used.

Examples of the halogen atom-containing organic group include a 2-bromo-2-methylpropionyloxy group, a 2-bromo-propionyloxy group, and a p-chlorosulfonylbenzoyloxy group.

An example of a method for introducing the halogen atom-containing organic group into one end of a compound containing a main chain including a silicone chain having a molecular weight of 2,000 or more is a method in which a compound (a1) having a functional group that can form a bond at one end of a silicone chain having a molecular weight of 2,000 or more by a reaction is allowed to react with a compound (a2) having a functional group that can react with the functional group to form a bond and having a halogen atom-containing organic group. Specific examples of the functional group located at one end of the compound (a1) include a hydroxy group, an isocyanate group, an epoxy group, a carboxy group, a carboxylic halide group, and a carboxylic anhydride group. Specific preferred examples of the compound (a1) having the functional group include compounds represented by formula (a1-1):

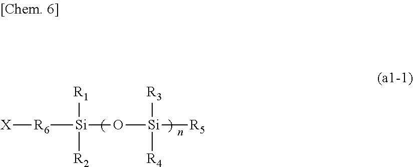

(wherein in the formula, X is a functional group that can form a bond by a reaction, R₁ to R₅ are each independently an alkyl group having 1 to 18 carbon atoms or a phenyl group, R6 is a divalent group or a single bond, and n is 20 to 200).

Examples of R₆ include alkylene groups having 1 or more carbon atoms, such as a methylene group, a propylene group, and an isopropylidene group, and an alkylene ether group in which two or more alkylene groups are linked by an ether linkage.

Examples of the functional group, which can react with the functional group located at one end of the compound (a1) to form a bond, of the compound (a2) are described below.

For example, in the case where the functional group of the compound (a1) is a hydroxy group, the functional group of the compound (a2) other than the halogen atom-containing organic group is preferably an isocyanate group, a carboxylic halide group, or a carboxylic anhydride. Another method may also be employed as follows: The hydroxy group of the compound (a1) is allowed to react with an acid anhydride to form a carboxy group. The carboxy group is allowed to react with a compound, serving as the compound (a2), having an epoxy group and a halogen atom-containing organic group to introduce the halogen atom-containing organic group into one end of the compound (a1).

In the case where the functional group of the compound (a1) is an isocyanate group, the functional group of the compound (a2) other than the halogen atom-containing organic group is preferably a hydroxy group. In the case where the functional group of the compound (a1) is an epoxy group, the functional group of the compound (a2) other than the halogen atom-containing organic group is preferably a carboxy group.

In the case where the functional group of the compound (a1) is a carboxy group, the functional group of the compound (a2) other than the halogen atom-containing organic group is preferably an epoxy group. In the case where the functional group of the compound (a1) is a carboxylic anhydride, the functional group of the compound (a2) other than the halogen atom-containing organic group is preferably a hydroxy group.

Among the combinations of the functional groups of the compound (a1) and the functional groups of the compound (a2) other than the halogen atom-containing organic group, a combination in which the functional group of the (a1) is a hydroxy group and the functional group of the compound (a2) other than the halogen atom-containing organic group is a carboxylic halide group is preferred because of the ease of a reaction. The reaction conditions in this combination are exemplified below.

Regarding a specific method for introducing the halogen atom-containing organic group into one end of the silicone chain, in the case where the functional group of the compound (a1) at one end is a hydroxy group and where the compound (a2) is a halogen group-containing carboxylic acid, a reaction can be performed under dehydration and esterification conditions to give a compound (A) having a functional group with an ability to initiate polymerization at one end of the main chain including the silicone chain having a molecular weight of 2,000 or more. In the case where the functional group of the compound (a1) at one end is a hydroxy group and where the compound (a2) is a halide of a halogen group-containing carboxylic acid, similarly, (a1) and (a2) can be reacted in a solvent, such as toluene or tetrahydrofuran, to give the compound (A) having a functional group with an ability to initiate polymerization. A basic catalyst can be used in this reaction, as needed.

In the case where the functional group of the compound (a1) at one end is an isocyanate group and where the compound (a2) has a halogen group and a hydroxy group serving as a functional group that can react with the isocyanate group, (a1) and (a2) can be reacted in the presence of a catalyst, such as tin octanoate, to give a compound having a functional group with an ability to initiate polymerization.

In the case where the functional group of the compound (a1) at one end is an epoxy group and where the compound (a2) has a halogen group and a carboxy group serving as a functional group that can react with the epoxy group, (a1) and (a2) can be reacted in the presence of triphenylphosphine or a basic catalyst, such as a tertiary amine, to give a compound having a functional group with an ability to initiate polymerization.

Specific examples of the compound (A) having the main chain including the silicone chain with a molecular weight of 2,000 or more and having the functional group with an ability to generate a radical at one end of the main chain include compounds represented by the following formulae.

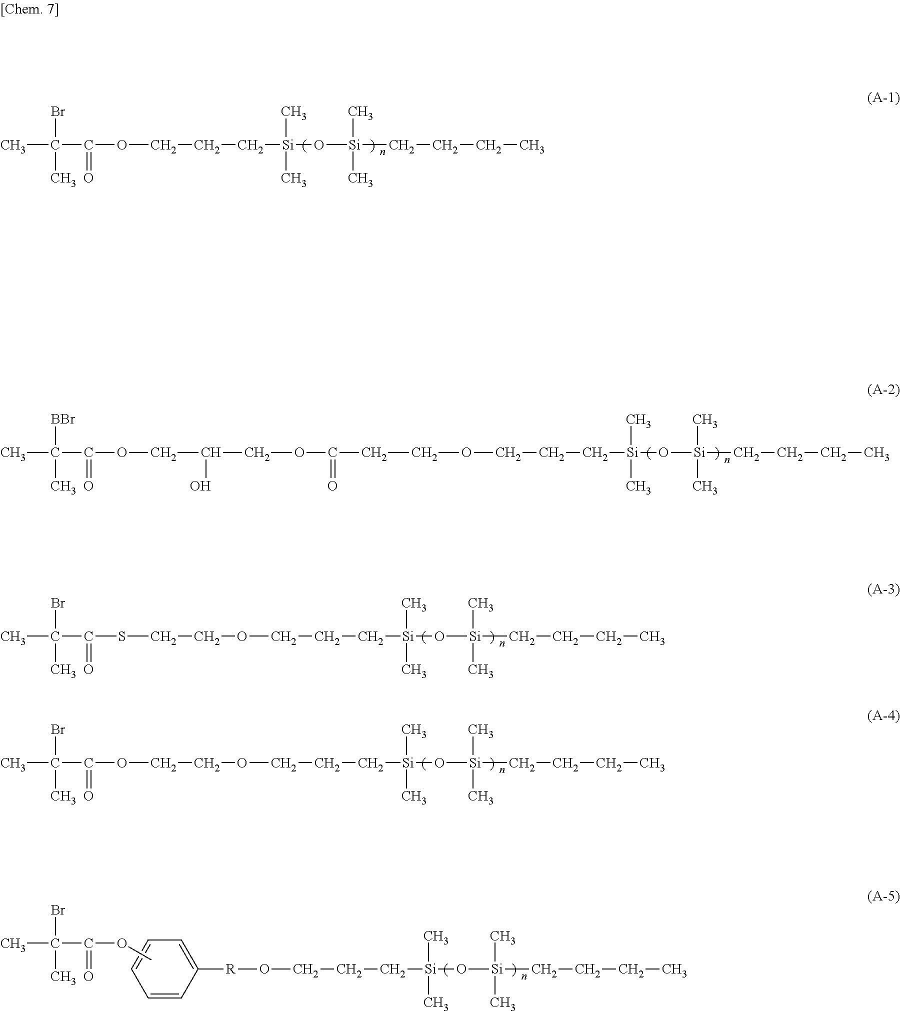

The polymerizable unsaturated monomer (B) will be described below. The polymerizable unsaturated monomer (B) has a fluorinated alkyl group having 1 to 6 carbon atoms to which a fluorine atom is directly attached. The fluorinated alkyl group also includes a group having one or more carbon-carbon double bonds in the framework of the fluorinated alkyl group. The polymerizable unsaturated group of the monomer (B) is preferably a radically polymerizable carbon-carbon unsaturated double bond. Examples thereof include (meth)acryloyl group, a vinyl group, and a maleimide group. Among these, a (meth)acryloyl group is preferred because of the ease of availability of raw materials, the ease of control of compatibility with components contained in the actinic energy ray-curable composition described below, and satisfactory polymerizability.

Examples of the polymerizable unsaturated monomer (B) having the fluorinated alkyl group include compounds represented by general formula (1) below.

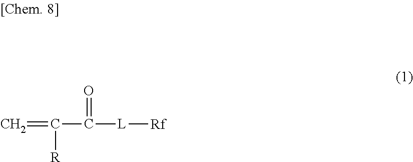

(In general formula (1), R is a hydrogen atom or a methyl group, L is any one of formulae (L-1) to (L-10) illustrated below, and Rf is any one of formulae (Rf-1) to (Rf-7)).

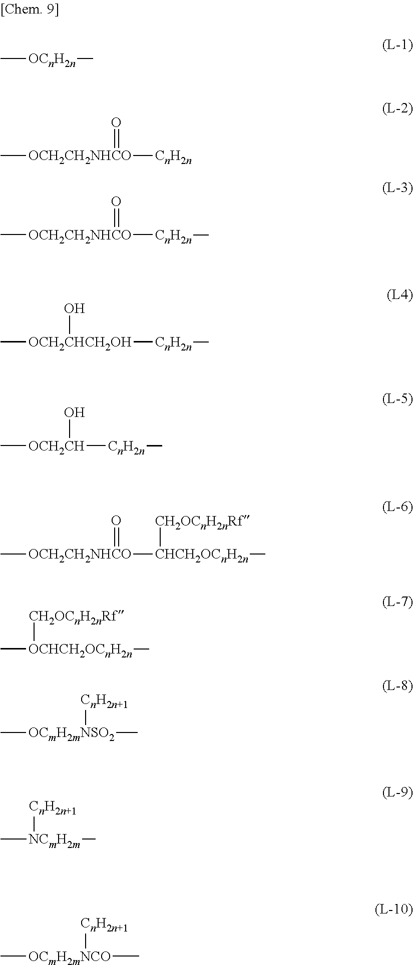

Each n in formulae (L-1), (L-3), (L-4), (L-5), (L-6), and (L-7) is an integer of 1 to 8. Each m in formulae (L-8), (L-9), and (L-10) is an integer of 1 to 8, and each n is an integer of 0 to 8. Rf″ in formulae (L-6) and (L-7) is any one of formulae (Rf-1) to (Rf-7) described below.

[Chem. 10]

—CₙF₂ₙ₊₁ (Rf-1)

—CₙF₂ₙH (Rf-2)

—CₙF₂ₙ₋₁ (Rf-3)

—CₙF₂ₙ₋₃ (Rf-4)

—CₘF₂ₘOCₙF₂ₙCF₃ (Rf-5)

—CₘF₂ₘOCₙF₂ₙOCₚF₂ₚCF₃ (Rf-6)

—CF₂OC₂F₄OC₂F₄OCF₃ (Rf-7)

Each n in formulae (Rf-1) and (Rf-2) is an integer of 1 to 6. n in (Rf-3) is an integer of 2 to 6. n in (Rf-4) is an integer of 4 to 6. m in formula (Rf-5) is an integer of 1 to 5, n is an integer of 0 to 4, and the sum of m and n is 4 or 5. m in formula (Rf-6) is an integer of 0 to 4, n is an integer of 1 to 4, p is an integer of 0 to 4, and the sum of m, n, and p is 4 or 5.

Specific examples of the monomer (B) include monomers (B-1) to (B-11) described below. These monomers (B) may be used alone or in combination of two or more.

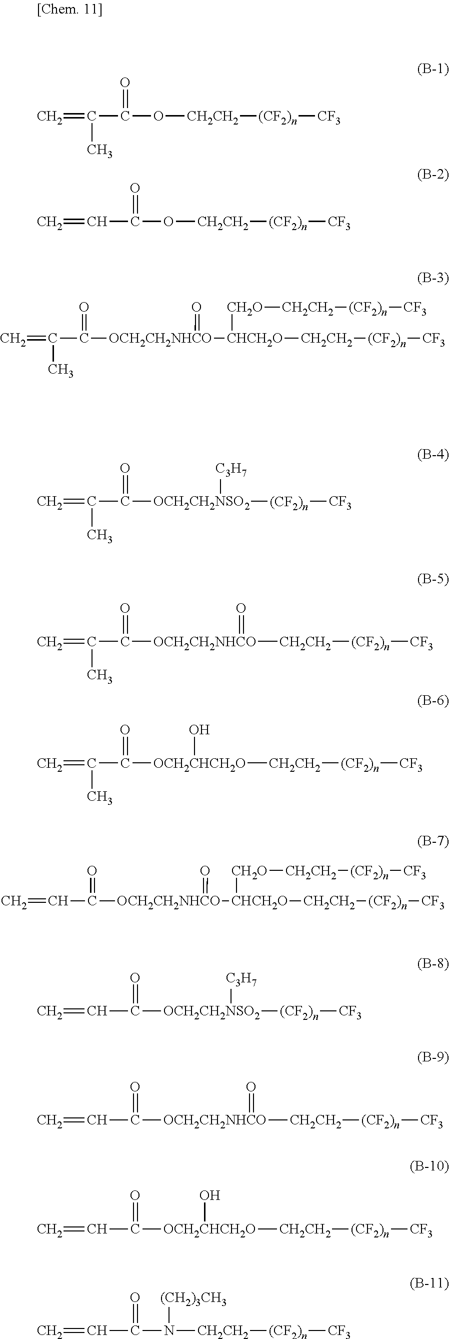

(In the formulae, each n is an integer of 0 to 5, preferably an integer of 3 to 5).

The polymerizable unsaturated monomer (C) having a reactive functional group (c1) will be described below. Examples of the functional group (c1) of the monomer (C) include a hydroxy group, an isocyanate group, an epoxy group, a carboxy group, a carboxylic halide group, and a carboxylic anhydride. The polymerizable unsaturated group of the monomer (C) is preferably a radically polymerizable carbon-carbon unsaturated double bond. Specific examples thereof include a vinyl group, a (meth)acryloyl group, and a maleimide group. A (meth)acryloyl group is more preferred because of the ease of polymerization.

Specific examples of the monomer (C) include hydroxy group-containing unsaturated monomers, such as 2-hydroxyethyl (meth)acrylate, 2-hydroxypropyl (meth)acrylate, 3-hydroxypropyl (meth) acrylate, 2-hydroxybutyl (meth)acrylate, 4-hydroxybutyl (meth)acrylate, 1,4-cyclohexanedimethanol mono(meth)acrylate, N-(2-hydroxyethyl) (meth)acrylamide, glycerol mono(meth)acrylate, poly(ethylene glycol) mono(meth)acrylate, poly(propylene glycol) mono(meth)acrylate, 2-hydroxy-3-phenoxypropyl (meth)acrylate, 2-(meth)acryloyloxyethyl-2-hydroxyethyl phthalate, and a lactone-modified (meth)acrylate having a hydroxy group at an end; isocyanate group-containing unsaturated monomers, such as 2-(meth)acryloyloxyethyl isocyanate, 2-(2-(meth)acryloyloxyethoxy)ethyl isocyanate, and 1,1-bis((meth)acryloyloxymethyl)ethyl isocyanate; epoxy group-containing unsaturated monomers, such as glycidyl methacrylate and 4-hydroxybutyl acrylate glycidyl ether; carboxy group-containing unsaturated monomers, such as (meth)acrylic acid, 2-(meth)acryloyloxyethylsuccinic acid, 2-(meth)acryloyloxyethylphthalic acid, maleic acid, and itaconic acid; and unsaturated double bond-containing carboxylic anhydrides, such as maleic anhydride and itaconic anhydride. These monomers (C) may be used alone or in combination of two or more.

When the copolymer (P), the polymer (Q1), and the polymer (Q2), which serve as intermediates, are produced, in addition to the compound (A), the monomer (B), and the monomer (C), another polymerizable unsaturated monomer copolymerizable therewith may be used. Examples of another polymerizable unsaturated monomer include (meth)acrylates, such as methyl (meth)acrylate, ethyl (meth)acrylate, n-propyl (meth)acrylate, n-butyl (meth)acrylate, isobutyl (meth)acrylate, n-pentyl (meth)acrylate, n-hexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, cyclohexyl (meth)acrylate, isobornyl (meth)acrylate, and (meth)acrylates having a polyoxyalkylene chain; aromatic vinyl compounds, such as styrene, α-methylstyrene, p-methylstyrene, and p-methoxystyrene; and maleimides, such as maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

The ratio by mass of the compound (B) to the monomer (C), i.e., (B)/(C), is preferably in the range of 10/90 to 90/10, more preferably 20/80 to 80/20 because a cured film having higher scratch resistance is formed.

An example of a method for producing the copolymer (P), the polymer (Q1), or the polymer (Q2) is a method in which the monomer (B) and the monomer (C) are subjected to living radical polymerization using the compound (A) serving as a radical polymerization initiator. In living radical polymerization, typically, a dormant species, in which an active polymerizable end is protected by an atom or atomic group, can reversibly form a radical and can react with a monomer to give a polymer having a significantly narrow molecular weight distribution. Examples of the living radical polymerization include atom transfer radical polymerization (ATRP), reversible addition-fragmentation chain transfer (RAFT) polymerization, nitroxide-mediated radical polymerization (NMP), and organotellurium-mediated radical polymerization (TERP). The production of the copolymer (P) by the living radical polymerization results in the copolymer having a significantly narrow molecular weight distribution and is thus preferred. There are no particular restrictions on which of these methods is used. ATRP is preferred because of its ease of control. In ATRP, polymerization is performed with an organic halide or a halogenated sulfonyl compound, serving as an initiator, and a metal complex, serving as a catalyst, composed of a transition metal compound and a ligand.

The transition metal compound used in ATRP is represented by Mⁿ⁺Xⁿ. Mⁿ⁺, which is a transition metal, can be selected from the group consisting of Cu+, Cu²⁺, Fe²⁺, Fe³⁺, Ru²⁺, Ru³⁺, Cr²⁺, Cr³⁺, Mo⁰, Mo⁺, Mo²⁺, Mo³⁺, W²⁺, W³⁺, Rh³⁺, Rh⁴⁺, Co⁺, Co²⁺, Re²⁺, Re³⁺, N⁰, Ni⁺, Mn³⁺, Mn⁴⁺, V²⁺, V³⁺, Zn⁺, Zn²⁺, Au⁺, Au²⁺, Ag⁺, and Ag²⁺. X can be selected from the group consisting of halogen atoms, alkoxy groups having 1 to 6 carbon atoms, (SO₄)_{1/2}, (PO₄)_{1/3}, (HPO₄)_{1/2}, (H₂PO₄) triflate, hexafluorophosphate, methanesulfonate, aryl sulfonates (preferably, benzenesulfonate or toluenesulfonate), SeR₁, CN, and R₂COO. R¹ is an aryl or a linear or branched alkyl group having 1 to 20 carbon atoms (preferably 1 to 10 carbon atoms). R2 is a hydrogen atom or a linear or branched alkyl group having 1 to 6 carbon atoms (preferably a methyl group) optionally substituted with 1 to 5 halogen atoms (preferably 1 to 3 fluorine or chlorine atoms). n represents the formal charge on the metal and is an integer of 0 to 7.

The transition metal complex is preferably a Group 7, 8, 9, 10, or 11 transition metal complex. A complex of zero or mono-valent copper, divalent ruthenium, divalent iron, or divalent nickel is more preferred.

Examples of a compound with a ligand that can coordinate with the transition metal include compounds with a ligand containing one or more nitrogen atoms, oxygen atoms, phosphorus atoms, or sulfur atoms that can coordinate with a transition metal with a 6 bond, compounds with a ligand containing two or more carbon atoms that can coordinate with a transition metal with a n bond, and compounds with a ligand that can coordinate with a transition metal with a μ bond or an η bond.

Specific examples of the compound with a ligand include, when the central metal is copper, complexes with ligands, such as 2,2′-bipyridyl and its derivatives, 1,10-phenanthroline and its derivatives, and polyamines, such as tetramethylethylenediamine, pentamethyldiethylenetriamine, and hexamethyltris(2-aminoethyl)amine. Examples of a divalent ruthenium complex include dichlorotris(triphenylphosphine)ruthenium, dichlorotris(tributylphosphine)ruthenium, dichloro(cyclooctadiene)ruthenium, dichloro(benzene)ruthenium, dichloro(p-cymene)ruthenium, dichloro(norbornadiene)ruthenium, cis-dichlorobis(2,2′-bipyridine) ruthenium, dichlorotris(1,10-phenanthroline)ruthenium, and carbonylchlorohydridotris(triphenylphosphine)ruthenium. Examples of a divalent iron complex include a bis(triphenylphosphine) complex and a triazacyclononane complex.

In the production of the copolymer (P), a solvent is preferably used. Examples of the solvent used include ester solvents, such as ethyl acetate, butyl acetate, and propylene glycol monomethyl ether acetate; ether solvents, such as diisopropyl ether, dimethoxyethane, and diethylene glycol dimethyl ether; halogenated solvents, such as dichloromethane and dichloroethane; aromatic solvents, such as toluene and xylene; ketone solvents, such as methyl ethyl ketone, methyl isobutyl ketone, and cyclohexanone; alcohol solvents, such as methanol, ethanol, and isopropanol; and aprotic polar solvents, such as dimethylformamide and dimethyl sulfoxide. These solvents may be used alone or in combination of two or more.

The polymerization temperature for the production of the copolymer (P), the polymer (Q1), and the polymer (Q2) is preferably in the range of room temperature to 100° C.

In the case where a copolymer portion composed of the monomer (B) and the monomer (C) in the copolymer (P) is in the form of blocks, the copolymer portion can be produced by subjecting the monomer (B) or the monomer (C) to living radical polymerization in the presence of the compound (A), a transition metal compound, a compound having a ligand that can coordinate with the transition metal, and a solvent, adding the monomer different from the monomer that has been subjected to living radical polymerization thereto, and further performing living radical polymerization.

To obtain the actinic energy ray-curable compound (II) according to the present invention, the polymerizable unsaturated group (y) is introduced into the copolymer (P) by using the compound (D) having the functional group (d1) reactive with the functional group (c1) and the polymerizable unsaturated group (d2) with respect to some or all of the reactive groups of the copolymer (P), the polymer (Q1), and the polymer (Q2) produced by the above method. Examples of the functional group (d1) of the compound (D) include a hydroxy group, an isocyanate group, an epoxy group, a carboxy group, a carboxylic halide group, and a carboxylic anhydride group. In the case where the reactive functional group (c1) of the monomer (C) is a hydroxy group, examples of the functional group (d1) include an isocyanate group, a carboxy group, a carboxylic halide group, a carboxylic anhydride group, and an epoxy group. In the case where the reactive functional group (c1) is an isocyanate group, an example of the functional group (d1) is a hydroxy group. In the case where the reactive functional group (c1) is an epoxy group, examples of the functional group (d1) include a carboxylic group and a hydroxy group. In the case where the reactive functional group (c1) is a carboxy group, examples of the functional group (d1) include an epoxy group and a hydroxy group. These multiple functional groups may be combined. Among combinations thereof, preferred are a combination in which the reactive functional group (c1) is a hydroxy group and the functional group (d1) is an isocyanate group and a combination in which the reactive functional group (c1) is an epoxy group and the functional group (d1) is a carboxy group.

The polymerizable unsaturated group (y) of the monomer (D) is preferably a radically polymerizable carbon-carbon unsaturated double bond. Specific examples thereof include a vinyl group, a (meth)acryloyl group, and a maleimide group. Among these, a (meth)acryloyl group is preferred, and an alryloyl group is more preferred, because of its high curability with another actinic energy ray-curable compound (III) and so forth.

Specific examples of the compound (D) include hydroxy group-containing unsaturated monomers, such as hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexanedimethanol mono(meth)acrylate, N-(2-hydroxyethyl) (meth)acrylamide, glycerol mono(meth)acrylate, poly(ethylene glycol) mono(meth)acrylate, poly(propylene glycol) mono(meth)acrylate, 2-hydroxy-3-phenoxypropyl (meth)acrylate, 2-(meth)acryloyloxyethyl-2-hydroxyethyl phthalate, and a lactone-modified (meth)acrylate having a hydroxy group at an end; isocyanate group-containing unsaturated monomers, such as 2-(meth)acryloyloxyethyl isocyanate, 2-(2-(meth)acryloyloxyethoxy)ethyl isocyanate, and 1,1-bis((meth)acryloyloxymethyl)ethyl isocyanate; epoxy group-containing unsaturated monomers, such as glycidyl methacrylate and 4-hydroxybutyl acrylate glycidyl ether; carboxy group-containing unsaturated monomers, such as (meth)acrylic acid, 2-(meth)acryloyloxyethylsuccinic acid, 2-(meth)acryloyloxyethylphthalic acid, maleic acid, and itaconic acid; and unsaturated double bond-containing carboxylic anhydrides, such as maleic anhydride and itaconic anhydride. As a compound having multiple polymerizable unsaturated groups, for example, 2-hydroxy-3-acryloyloxypropyl methacrylate, pentaerythritol triacrylate, or dipentaerythritol pentaacrylate may be used. These compounds (D) may be used alone or in combination of two or more.

Among the specific compounds (D), preferred are 2-hydroxyethyl acrylate, 2-hydroxypropyl acrylate, 3-hydroxypropyl acrylate, 2-hydroxybutyl acrylate, 4-hydroxybutyl acrylate, 1,4-cyclohexanedimethanol monoacrylate, N-(2-hydroxyethyl)acrylamide, 2-acryloyloxyethyl isocyanate, 1,1-bis(acryloyloxymethyl)ethyl isocyanate, 4-hydroxybutyl acrylate glycidyl ether, and acrylic acid, because polymerization curability by ultraviolet irradiation is particularly preferred.

The method for allowing the copolymer (P), the polymer (Q1), or the polymer (Q2) to react with the compound (D) may be performed under conditions in which the polymerizable unsaturated group of the compound (D) or the like is not polymerized. For example, the temperature condition is preferably adjusted to the range of 30° C. to 120° C. for the reaction. The reaction is preferably performed in the presence of a catalyst, a polymerization inhibitor, and if necessary, an organic solvent.

For example, in the case where the reactive functional group (c1) is a hydroxy group and where the functional group (d1) is an isocyanate group, a method is preferred in which the reaction is performed with, for example, p-methoxyphenol, hydroquinone, or 2,6-di-tert-butyl-4-methylphenol serving as a polymerization inhibitor, and, for example, dibutyltin dilaurate, dibutyltin diacetate, tin octanoate, or zinc octanoate serving as a catalyst for a urethane-forming reaction at a reaction temperature of 40° C. to 120° C., particularly 60° C. to 90° C. In the case where the reactive functional group (c1) is an epoxy group and where the functional group (d1) is a carboxy group or in the case where the reactive functional group (c1) is a carboxy group and where the functional group (d1) is an epoxy group, the reaction is preferably performed with, for example, p-methoxyphenol, hydroquinone, or 2,6-di-tert-butyl-4-methylphenol serving as a polymerization inhibitor, and, for example, a tertiary amine, such as triethylamine, a quaternary ammonium salt, such as tetramethylammonium chloride, a tertiary phosphine, such as triphenylphosphine, or a quaternary phosphonium, such as tetrabutylphosphonium chloride, serving as a catalyst for an esterification reaction at a reaction temperature of 80° C. to 130° C., particularly 100° C. to 120° C.

As the organic solvent used for the reaction, preferred are ketones, esters, amides, sulfoxides, ethers, and hydrocarbons. Specific examples thereof include acetone, methyl ethyl ketone, methyl isobutyl ketone, cyclohexanone, ethyl acetate, butyl acetate, propylene glycol monomethyl ether acetate, dimethylformamide, dimethylacetamide, N-methylpyrrolidone, dimethyl sulfoxide, diethyl ether, diisopropyl ether, tetrahydrofuran, dioxane, toluene, and xylene. These may be appropriately selected in view of their boiling points and compatibility.

In the case where the compound (II) obtained as described above is in the form of a random copolymer, the number-average molecular weight (Mn) is preferably in the range of 3,000 to 100,000, more preferably 10,000 to 50,000 because gelation during the production is easily prevented. The weight-average molecular weight (Mw) is preferably in the range of 3,000 to 150,000, more preferably 10,000 to 75,000. The polydispersity index (Mw/Mn) is preferably 1.0 to 1.5, more preferably 1.0 to 1.3, most preferably 1.0 to 1.2.

In the case where the compound (II) obtained as described above is in the form of a block copolymer, the number-average molecular weight (Mn) is preferably in the range of 3,000 to 100,000, more preferably 6,000 to 50,000, even more preferably 8,000 to 25,000 because gelation during the production is easily prevented. The weight-average molecular weight (Mw) is preferably in the range of 3,000 to 150,000, more preferably 8,000 to 65,000, even more preferably 10,000 to 35,000. The polydispersity index (Mw/Mn) is preferably 1.0 to 1.5, 1.0 to 1.4, most preferably 1.0 to 1.3.

The number-average molecular weight (Mn) and the weight-average molecular weight (Mw) are values measured by gel permeation chromatography (hereinafter, abbreviated as “GPC”) in terms of polystyrene. The measurement conditions of GPC are described below.
[GPC Measurement Condition]
Measurement device: “HLC-8220 GPC”, available from Tosoh Corp.
Column: Tosoh Corp. “HHR-H” guard column (6.0 mm I.D.×4 cm)+Tosoh Corp. “TSK-GEL GMHHR-N” (7.8 mm I.D.×30 cm) +Tosoh Corp. “TSK-GEL GMHHR-N” (7.8 mm I.D.×30 cm)+Tosoh Corp. “TSK-GEL GMHHR-N” (7.8 mm I.D.×30 cm)+Tosoh Corp. “TSK-GEL GMHHR-N” (7.8 mm I.D.×30 cm)
Detector: ELSD (Alltech Japan “ELSD2000”)
Data processing: “GPC-8020 Model II, data analysis version 4.30”, available from Tosoh Corp.
Measurement conditions: Column temperature: 40° C.
   Eluent: tetrahydrofuran (THF)
   Flow rate: 1.0 ml/min
Sample: a solution (5 μl) obtained by filtering a 1.0% by mass tetrahydrofuran solution in terms of resin solid content through a microfilter
Standard sample: monodisperse polystyrenes having known molecular weights were used in accordance with the measurement manual of “GPC-8020 Model II, data analysis version 4.30”.

### (Monodisperse Polystyrene)

“A-500”, available from Tosoh Corp.
“A-1000”, available from Tosoh Corp.
“A-2500”, available from Tosoh Corp.
“A-5000”, available from Tosoh Corp.
“F-1”, available from Tosoh Corp.
“F-2”, available from Tosoh Corp.
“F-4”, available from Tosoh Corp.
“F-10”, available from Tosoh Corp.
“F-20”, available from Tosoh Corp.
“F-40”, available from Tosoh Corp.
“F-80”, available from Tosoh Corp.
“F-128”, available from Tosoh Corp.
“F-288”, available from Tosoh Corp.
“F-550”, available from Tosoh Corp.

The equivalent weight of the polymerizable unsaturated groups of the compound (II) is preferably in the range of 200 to 3,500 g/eq., more preferably 250 to 2,500 g/eq., more preferably 250 to 2,000 g/eq., more preferably 300 to 2,000 g/eq., even more preferably 300 to 1,500 g/eq., even more preferably 400 to 1,500 g/eq., particularly preferably 400 to 1,000 g/eq. from the viewpoint of achieving better scratch resistance of a cured film to be formed.

In the case where the compound (II) is in the form of a block copolymer, the ratio by mass of the first polymer segment (α) to the second polymer segment (β) in the compound, i.e., (α)/(β), is preferably in the range of 10/90 to 90/10, more preferably 20/80 to 80/20, even more preferably 30/70 to 70/30 because it has excellent compatibility with other resins and can satisfactorily segregate the silicone chain that contributes to high scratch resistance of a surface of a coating film.

In the present invention, the polyfunctional compound (I) and the actinic energy ray-curable compound (II) are used in combination. The ratio (I)/(II) (by mass) is preferably in the range of 90/10 to 30/70, particularly preferably 85/15 to 35/65 from the viewpoint of achieving good performance balance among, for example, the scratch resistance, durability, excellent appearance, low reflectance, and a low refractive index of a cured film to be formed.

In the present invention, both of the polyfunctional compound (I) and the actinic energy ray-curable compound (II) are curable with an actinic energy ray. Thus, a cured film can be formed only from these compounds. Another actinic energy ray-curable compound (III) may be used in addition thereto to prepare a composition that provides a cured film having a better performance balance.

Any compound having a photopolymerizable functional group that can be polymerized or crosslinked by irradiation with actinic energy rays, such as ultraviolet rays, may be used as another actinic energy ray-curable compound (III) without particular limitation.

As the actinic energy ray-curable compound (III), an actinic energy ray-curable monomer (III-1) is exemplified. Examples of the monomer (III-1) include ethylene glycol di(meth)acrylate, diethylene glycol di(meth)acrylate, triethylene glycol di(meth)acrylate, poly(ethylene glycol) di(meth)acrylate having a number-average molecular weight of 150 to 1,000, propylene glycol di(meth)acrylate, dipropylene glycol di(meth)acrylate, tripropylene glycol di(meth)acrylate, poly(propylene glycol) di(meth)acrylate having a number-average molecular weight of 150 to 1,000, neopentyl glycol di(meth)acrylate, 1,3-butanediol di(meth)acrylate, 1,4-butanediol di(meth)acrylate, 1,6-hexanediol di(meth)acrylate, neopentylglycol hydroxypivalate di(meth)acrylate, bisphenol A di(meth)acrylate, trimethylolpropane tri(meth)acrylate, pentaerythritol tri(meth)acrylate, dipentaerythritol hexa(meth)acrylate, pentaerythritol tetra(meth)acrylate, trimethylolpropane di(meth)acrylate, dipentaerythritol penta(meth)acrylate, dicyclopentenyl (meth)acrylate, aliphatic alkyl (meth)acrylates, such as methyl (meth)acrylate, propyl (meth)acrylate, butyl (meth)acrylate, tert-butyl (meth)acrylate, 2-ethylhexyl (meth)acrylate, octyl (meth)acrylate, decyl (meth)acrylate, isodecyl (meth)acrylate, lauryl (meth)acrylate, stearyl (meth)acrylate, and isostearyl (meth)acrylate, glycerol (meth) acrylate, 2-hydroxyethyl (meth) acrylate, 3-chloro-2-hydroxypropyl (meth)acrylate, glycidyl (meth)acrylate, allyl (meth)acrylate, 2-butoxyethyl (meth)acrylate, 2-(diethylamino)ethyl (meth)acrylate, 2-(dimethylamino)ethyl (meth)acrylate, γ-(meth)acryloxypropyltrimethoxysilane, 2-methoxyethyl (meth)acrylate, methoxy diethylene glycol (meth)acrylate, methoxy dipropylene glycol (meth)acrylate, nonylphenoxy poly(ethylene glycol) (meth)acrylate, nonylphenoxy poly(propylene glycol) (meth) acrylate, phenoxyethyl (meth)acrylate, phenoxy dipropylene glycol (meth)acrylate, phenoxy poly(propylene glycol) (meth) acrylate, polybutadiene (meth) acrylate, poly(ethylene glycol)-poly(propylene glycol) (meth)acrylate, poly(ethylene glycol)-poly(butylene glycol) (meth) acrylate, polystyrylethyl (meth) acrylate, benzyl (meth) acrylate, cyclohexyl (meth) acrylate, dicyclopentanyl (meth) acrylate, dicyclopentenyl (meth) acrylate, isobornyl (meth) acrylate, methoxy-modified cyclodecatriene (meth)acrylate, and phenyl (meth) acrylate.

Among these, polyfunctional (meth)acrylates having three or more functionalities, such as trimethylolpropane tri(meth)acrylate, pentaerythritol tri(meth)acrylate, dipentaerythritol hexa(meth)acrylate, and pentaerythritol tetra(meth)acrylate are preferred because a cured film is excellent in hardness. These actinic energy ray-curable monomers (III-1) may be used alone or in combination of two or more.

As the actinic energy ray-curable compound (III), an actinic energy ray-curable resin (III-2) can also be used. Examples of the actinic energy ray-curable resin (III-2) include urethane (meth)acrylate resins, unsaturated polyester resins, epoxy (meth)acrylate resins, polyester (meth)acrylate resins, and acrylic (meth)acrylate resins. In the present invention, in particular, a urethane (meth)acrylate resin is preferred from the viewpoint of transparency and low shrinkage.

An example of the urethane (meth)acrylate resin used here is a resin having a (meth)acryloyl group and a urethane linkage formed by allowing an aliphatic polyisocyanate compound or an aromatic polyisocyanate compound to react with a hydroxy group-containing (meth)acrylate compound.

Examples of the aliphatic polyisocyanate compound include tetramethylene diisocyanate, pentamethylene diisocyanate, hexamethylene diisocyanate, heptamethylene diisocyanate, octamethylene diisocyanate, decamethylene diisocyanate, 2-methyl-1,5-pentane diisocyanate, 3-methyl-1,5-pentane diisocyanate, dodecamethylene diisocyanate, 2-methylpentamethylene diisocyanate, 2,2,4-trimethylhexamethylene diisocyanate, 2,4,4-trimethylhexamethylene diisocyanate, isophorone diisocyanate, norbornane diisocyanate, hydrogenated dimethylmethane diisocyanate, hydrogenated tolylene diisocyanate, hydrogenated xylylene diisocyanate, hydrogenated tetramethyl xylylene diisocyanate, and cyclohexyl diisocyanate. Examples of the aromatic polyisocyanate compound include tolylene diisocyanate, 4,4′-diphenylmethane diisocyanate, xylylene diisocyanate, 1,5-naphthalene diisocyanate, tolidine diisocyanate, and p-phenylene diisocyanate.

Examples of the hydroxy group-containing acrylate compound include mono(meth)acrylates of dihydric alcohols, such as 2-hydroxyethyl (meth)acrylate, 2-hydroxypropyl (meth)acrylate, 2-hydroxybutyl (meth)acrylate, 4-hydroxybutyl (meth)acrylate, 1,5-pentanediol mono(meth)acrylate, 1,6-hexanediol mono(meth)acrylate, neopentyl glycol mono(meth)acrylate, and neopentylglycol hydroxypivalate mono(meth)acrylate; mono- and di-(meth)acrylates of trihydric alcohols, such as trimethylolpropane di(meth)acrylate, ethoxylated trimethylolpropane (meth) acrylate, propoxylated trimethylolpropane di(meth)acrylate, glycerol di(meth)acrylate, and bis(2-(meth)acryloyloxyethyl)hydroxyethyl isocyanurate, and hydroxy group-containing mono- and di-(meth)acrylates in which these alcoholic hydroxy groups are partially modified by E-caprolactone; compounds having a monofunctional hydroxy group and tri- or higher functional (meth)acryloyl group, such as pentaerythritol tri(meth)acrylate, ditrimethylolpropane tri(meth)acrylate, and dipentaerythritol penta(meth)acrylate, and hydroxy group-containing multifunctional (meth)acrylates in which these compounds are modified by E-caprolactone; (meth)acrylate compounds having oxyalkylene chains, such as dipropylene glycol mono(meth)acrylate, diethylene glycol mono(meth)acrylate, polypropylene glycol mono(meth)acrylate, and polyethylene glycol mono(meth)acrylate; (meth)acrylate compounds having block-structured oxyalkylene chains, such as polyethylene glycol-polypropylene glycol mono(meth)acrylate, polyoxybutylene-polyoxypropylene mono(meth)acrylate; and (meth)acrylate compounds having random-structured oxyalkylene chains, such as poly(ethylene glycol-tetramethylene glycol) mono(meth)acrylate, poly(propylene glycol-tetramethylene glycol) mono(meth)acrylate.

The reaction of the aliphatic polyisocyanate compound or the aromatic polyisocyanate compound with the hydroxy group-containing acrylate compound can be performed in the usual manner in the presence of a catalyst for urethane formation. Specific examples of the catalyst that can be used here for urethane formation include amines, such as pyridine, pyrrole, triethylamine, diethylamine, and dibutylamine; phosphines, such as triphenylphosphine and triethylphosphine; organotin compounds, such as dibutyltin dilaurate, octyltin trilaurate, octyltin diacetate, dibutyltin diacetate, and tin octanoate; and organometallic compounds, such as zinc octanoate.

Among these urethane acrylate resins, in particular, a resin formed by allowing the aliphatic polyisocyanate compound to react with the hydroxy group-containing (meth)acrylate compound is preferred because a cured coating film is excellent in transparency and the resin has satisfactory sensitivity to an actinic energy rays and excellent curability.

An unsaturated polyester resin is a curable resin formed by the polycondensation of an α,β-unsaturated dibasic acid or the anhydride of the acid, an aromatic unsaturated dibasic acid or the anhydride of the acid, and a glycol. Examples of the α,β-unsaturated dibasic acid or the anhydride of the acid include maleic acid, maleic anhydride, fumaric acid, itaconic acid, citraconic acid, chloromaleic acid, and esters thereof. Examples of the aromatic unsaturated dibasic acid or the anhydride of the acid include phthalic acid, phthalic anhydride, isophthalic acid, terephthalic acid, nitrophthalic acid, tetrahydrophthalic anhydride, endomethylenetetrahydrophthalic anhydride, halogenated phthalic anhydride, and esters thereof. Examples of an aliphatic or alicyclic saturated dibasic acid include oxalic acid, malonic acid, succinic acid, adipic acid, sebacic acid, azelaic acid, glutaric acid, hexahydrophthalic anhydride, and esters thereof. Examples of the glycol include ethylene glycol, propylene glycol, diethylene glycol, dipropylene glycol, 1,3-butanediol, 1,4-butanediol, 2-methylpropane-1,3-diol, neopentyl glycol, triethylene glycol, tetraethylene glycol, 1,5-pentanediol, 1,6-hexanediol, bisphenol A, hydrogenated bisphenol A, ethylene glycol carbonate, and 2,2-di-(4-hydroxypropoxydiphenyl)propane. In addition, an oxide, such as ethylene oxide or propylene oxide, may also be used.

Examples of epoxy vinyl ester resins include a resin formed by allowing an epoxy group of an epoxy resin, such as a bisphenol A-type epoxy resin, a bisphenol F-type epoxy resin, a phenol novolac-type epoxy resin, or a cresol novolac-type epoxy resin, to react with (meth)acrylic acid. These actinic energy ray-curable resins (III-2) may be used alone or in combination of two or more.

The actinic energy ray-curable monomer (III-1) and the actinic energy ray-curable resin (III-2) may be used alone or in combination.

In the case of forming a cured film having a lower refractive index, in particular, in the case of using the cured film as an antireflection film, a refractive index-lowering agent (IV) is preferably used in addition thereto.

The refractive index-lowering agent (IV) preferably has a refractive index of 1.44 or less, more preferably 1.40 or less. The refractive index-lowering agent (IV) may be an inorganic or organic low-refractive-index agent.

Examples of the inorganic refractive index-lowering agent (IV) include fine particles having voids and fine metal fluoride particles. Examples of the fine particles having voids include fine particles containing a gas therein and fine particles having a porous structure containing a gas therein. Specific examples thereof include fine hollow silica particles and fine silica particles having a nanoporous structure. Examples of the fine metal fluoride particles include magnesium fluoride, aluminum fluoride, calcium fluoride, and lithium fluoride.

Among these inorganic refractive index-lowering agents (IV), fine hollow silica particles are preferred. These inorganic refractive index-lowering agents (IV) may be used alone or in combination of two or more. These inorganic refractive index-lowering agents (I) may be used in the form of crystals, sols, or gels.

The shape of the fine silica particles may be any of a spherical shape, a chain-like shape, a needle-like shape, a plate-like shape, a scale-like shape, a rod-like shape, a fibrous shape, and an indefinite shape. Among these, the spherical shape or needle-like shape is preferred. The fine silica particles preferably have an average particle size of 5 to 100 nm, more preferably 20 to 80 nm, even more preferably 40 to 70 nm when the fine silica particles are spherical. When the average particle size of the spherical fine particles is in the range, excellent transparency can be imparted to a low-refractive-index layer.

Examples of the organic refractive index-lowering agent (IV) include fine particles having voids and fluorine-containing copolymers. As the fine particles having voids, fine hollow polymer particles are preferred. The fine hollow polymer particles can be produced by dispersing a mixture of (1) at least one crosslinkable monomer, (2) a polymerization initiator, (3) a polymer obtained from at least one crosslinkable monomer or a copolymer of at least one crosslinkable monomer and at least one monofunctional monomer, and a poorly water-soluble solvent having low compatibility with (1) to (3) in an aqueous solution of a dispersion stabilizer and performing suspension polymerization. The crosslinkable monomer used here refers to a crosslinkable monomer having two or more polymerizable groups, and the monofunctional monomer refers to a crosslinkable monomer having one polymerizable group.

The fluorine-containing copolymer used as the organic refractive index-lowering agent (IV) is a resin having a low refractive index due to a large amount of fluorine atoms contained in the resin. An example of the fluorine-containing copolymer is a copolymer of vinylidene fluoride and hexafluoropropylene serving as raw material monomers.

With respect to the proportions of the monomers serving as the raw materials of the fluorine-containing copolymer, the proportion of vinylidene fluoride is preferably 30% to 90% by mass, more preferably 40% to 80% by mass, even more preferably 40% to 70% by mass. The proportion of hexafluoropropylene is preferably 5% to 50% by mass, more preferably 10% to 50% by mass, even more preferably 15% to 45%. As another monomer, tetrafluoroethylene may be used in the range of 0% to 40% by mass.

Examples of other raw-material monomer components that can be used for the fluorine-containing copolymer include fluorine atom-containing polymerizable monomers, such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and u-trifluoromethacrylic acid. These other raw-material monomer components are preferably used in the range of 20% or less by mass in the raw-material monomers of the fluorine-containing copolymer.

The fluorine-containing copolymer preferably has a fluorine content of 60% to 70% by mass, more preferably 62% to 70% by mass, even more preferably 64% to 68% by mass. When the fluorine content of the fluorine-containing copolymer is in the above range, satisfactory solubility in a solvent is provided, excellent adhesion to various substrates is provided, and a thin film having high transparency, a low refractive index, and excellent mechanical strength can be formed.

The fluorine-containing copolymer preferably has a number-average molecular weight of 5,000 to 200,000, more preferably 10,000 to 100,000 in terms of polystyrene. When the molecular weight of the fluorine-containing copolymer is in the above range, the viscosity of the resulting resin is in the range where excellent coatability is provided. The fluorine-containing copolymer itself preferably has a refractive index of 1.45 or less, more preferably 1.42 or less, even more preferably 1.40 or less.

The proportion of the refractive index-lowering agent (IV) used is not particularly limited. The ratio by mass of the refractive index-lowering agent (IV) to the total of the actinic energy ray-curable compounds (I), (II), and (III), i.e., (IV):(I)+(II)+(III), is preferably in the range of 30:70 to 90:10, more preferably 30:70 to 70:30, even more preferably 30:70 to 60:40.

The actinic energy ray-curable composition of the present invention may further contain another fluorine-containing compound. Examples of the fluorine-containing compound that can be used here include compounds having a perfluoroalkyl group with 1 to 6 carbon atoms to which a fluorine atom is directly attached and compounds having a PFPE chain similar to the PFPE chain in the polyfunctional compound (I). These compounds may be synthesized compounds or commercially available compounds. Examples of the commercially available compounds include Megaface F-251, F-253, F-477, F-553, F-554, F-556, F-558, F-559, F-560, F-561, F-562, F-568, F-569, F-574, R-40, RS-75, RS-56, RS-76-E, RS-78, and RS-90 [available from DIC Corporation], Fluorad FC430, FC431, and FC171 (available from Sumitomo 3M Limited), and Surflon S-382, SC-101, SC-103, SC-104, SC-105, SC1068, SC-381, SC-383, 5393, and KH-40 [available from AGC Inc]. Among these, from the viewpoint of compatibility with the polyfunctional compound (I) and the actinic energy ray-curable compound (II), a surfactant having a PFPE chain is preferred. A compound (V) having a poly(perfluoroalkylene ether) chain and a polymerizable unsaturated group is preferably used because detachment from a surface of a cured film is less likely to occur and the long-term performance of the surface of the cured film is maintained.

The compound (V) having the poly(perfluoroalkylene ether) chain and the polymerizable unsaturated group may be a synthesized compound or a commercially available compound. For example, a compound disclosed in International Publication No. 2009/133770 may be used.

That is, the compound (V) having the PFPE chain and the polymerizable unsaturated group is preferably a reaction product of a copolymer and a compound (V-3), the copolymer being obtained from, as essential raw materials, a compound (V-1) having a structural moiety including a PFPE chain and a polymerizable unsaturated group at its end and a polymerizable unsaturated monomer (V-2) having a reactive functional group (α), the compound (V-3) having a polymerizable unsaturated group and a reactive functional group (β) reactive with the reactive functional group (α).

An example of the PFPE chain of the compound (V-1) having the structural moiety including the PFPE chain and the polymerizable unsaturated group at its end is a chain having a structure in which divalent fluorocarbon groups having 1 to 3 carbon atoms and oxygen atoms are alternately linked, and is the same as described above.

A compound before introducing the polymerizable unsaturated group at the end, the compound serving as a raw material for the compound (V-1) having the PFPE chain and the polymerizable unsaturated group, is the same as described above. A compound containing the PFPE chain having a hydroxy group, a carboxy group, isocyanate, or an epoxy group at an end of the chain can be used.

Examples of the polymerizable unsaturated monomer (V-2) having the reactive functional group (α) include acrylic monomers, aromatic vinyl monomers, vinyl ester monomers, and maleimide monomers, each of the monomers having the reactive functional group (α).

Examples of the reactive functional group (α) include a hydroxy group, an isocyanate group, an epoxy group, and a carboxy group. Examples of the polymerizable unsaturated monomer (II-2) having the reactive functional group (α) include hydroxy group-containing unsaturated monomers, such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexanedimethanol mono(meth)acrylate, N-(2-hydroxyethyl) (meth)acrylamide, glycerol mono(meth)acrylate, poly(ethylene glycol) mono(meth)acrylate, poly(propylene glycol) mono(meth)acrylate, 2-hydroxy-3-phenoxypropyl (meth)acrylate, 2-(meth)acryloyloxyethyl-2-hydroxyethyl phthalate, and a lactone-modified (meth)acrylate having a hydroxy group at an end; isocyanate group-containing unsaturated monomers, such as 2-(meth)acryloyloxyethyl isocyanate, 2-(2-(meth)acryloyloxyethoxy)ethyl isocyanate, and 1,1-bis((meth)acryloyloxymethyl)ethyl isocyanate; epoxy group-containing unsaturated monomers, such as glycidyl methacrylate and 4-hydroxybutyl acrylate glycidyl ether; carboxy group-containing unsaturated monomers, such as (meth)acrylic acid, 2-(meth)acryloyloxyethylsuccinic acid, 2-(meth)acryloyloxyethylphthalic acid, maleic acid, and itaconic acid; and unsaturated double bond-containing carboxylic anhydrides, such as maleic anhydride and itaconic anhydride.

Furthermore, another polymerizable unsaturated monomer that can be copolymerized with the compound (V) may be used. Examples thereof include (meth)acrylates, such as methyl (meth)acrylate, ethyl (meth)acrylate, n-propyl (meth)acrylate, n-butyl (meth)acrylate, isobutyl (meth)acrylate, n-pentyl (meth)acrylate, n-hexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, cyclohexyl (meth)acrylate, and isobornyl (meth)acrylate; aromatic vinyl compounds, such as styrene, α-methylstyrene, p-methylstyrene, and p-methoxystyrene; and maleimides, such as maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

An example of a method for producing the copolymer from, as essential raw materials, the compound (V-1) having the structural moiety including the PFPE chain and the polymerizable unsaturated group at its end and the polymerizable unsaturated monomer (V-2) having the reactive functional group (α) is a method in which the compound (V-1), the polymerizable unsaturated monomer (V-2) having the reactive functional group (α), and, if necessary, another polymerizable unsaturated monomer are polymerized in an organic solvent with a radical polymerization initiator. Preferred examples of the organic solvent used here include ketones, esters, amides, sulfoxides, ethers, and hydrocarbons. Specific examples thereof include acetone, methyl ethyl ketone, methyl isobutyl ketone, cyclohexanone, ethyl acetate, butyl acetate, propylene glycol monomethyl ether acetate, dimethylformamide, dimethylacetamide, N-methylpyrrolidone, dimethyl sulfoxide, diethyl ether, diisopropyl ether, tetrahydrofuran, dioxane, toluene, and xylene. These may be appropriately selected in view of their boiling points, compatibility, and polymerizability. Examples of the radical polymerization initiator include peroxides, such as benzoyl peroxide, and azo compounds, such as azobisisobutyronitrile. A chain transfer agent can also be used as needed. Examples thereof include lauryl mercaptan, 2-mercaptoethanol, thioglycerol, ethylthioglycolic acid, and octylthioglycolic acid.

The molecular weight of the resulting copolymer needs to be within a range in which insolubilization by crosslinking does not occur during polymerization. An excessively high molecular weight may result in insolubilization by crosslinking. Within the range, the copolymer preferably has a number-average molecular weight (Mn) of 800 to 3,000, particularly preferably 1,000 to 2,500, and preferably has a weight-average molecular weight (Mw) of 1,500 to 40,000, particularly preferably 2,000 to 30,000 from the viewpoint of increasing the number of polymerizable unsaturated groups of the finally obtained compound (V) in one molecule.

The target compound (V) is formed by allowing the copolymer formed as described above to react with the compound (V-3) having the reactive functional group (β) reactive with the reactive functional group (α) and the polymerizable unsaturated group.

Examples of the reactive functional group (β) reactive with the reactive functional group (α) include a hydroxy group, an isocyanate group, an epoxy group, and a carboxy group. In the case where the reactive functional group (α) is a hydroxy group, examples of the functional group (β) include an isocyanate group, a carboxy group, a carboxylic halide group, or an epoxy group. In the case where the reactive functional group (α) is an isocyanate group, an example of the functional group (β) is a hydroxy group. In the case where the reactive functional group (α) is an epoxy group, examples of the functional group (β) include a carboxy group or a hydroxy group. In the case where the reactive functional group (α) is a carboxy group, examples of the functional group (β) include an epoxy group or a hydroxy group.

Specific examples of the compound (V-3) include, in addition to the examples of the polymerizable unsaturated monomer having the reactive functional group (α), 2-hydroxy-3-acryloyloxypropyl methacrylate, pentaerythritol triacrylate, and dipentaerythritol pentaacrylate.

Among these, preferred are 2-hydroxyethyl acrylate, 2-hydroxypropyl acrylate, 3-hydroxypropyl acrylate, 2-hydroxybutyl acrylate, 4-hydroxybutyl acrylate, 1,4-cyclohexanedimethanol monoacrylate, N-(2-hydroxyethyl) acrylamide, 2-acryloyloxyethyl isocyanate, 4-hydroxybutyl acrylate glycidyl ether, and acrylic acid, because polymerization curability by ultraviolet irradiation is particularly preferred.

A method for allowing the copolymer to react with the compound (V-3) may be performed under conditions in which the polymerizable unsaturated group of the compound (V-3) is not polymerized. For example, the temperature condition is preferably adjusted to the range of 30° C. to 120° C. for the reaction. The reaction is preferably performed in the presence of a catalyst and a polymerization inhibitor, and if necessary, an organic solvent.

For example, in the case where the functional group (α) is a hydroxy group and where the functional group (β) is an isocyanate group or in the case where the functional group (α) is an isocyanate group and where the functional group (β) is a hydroxy group, a method is preferred in which the reaction is performed with, for example, p-methoxyphenol, hydroquinone, or 2,6-di-tert-butyl-4-methylphenol serving as a polymerization inhibitor, and, for example, dibutyltin dilaurate, dibutyltin diacetate, tin octanoate, or zinc octanoate serving as a catalyst for a urethane-forming reaction at a reaction temperature of 40° C. to 120° C., particularly 60° C. to 90° C. In the case where the functional group (α) is an epoxy group and where the functional group (β) is a carboxy group or in the case where the functional group (α) is a carboxy group and where the functional group (β) is an epoxy group, the reaction is preferably performed with, for example, p-methoxyphenol, hydroquinone, or 2,6-di-tert-butyl-4-methylphenol serving as a polymerization inhibitor, and, for example, a tertiary amine, such as triethylamine, a quaternary ammonium salt, such as tetramethylammonium chloride, a tertiary phosphine, such as triphenylphosphine, or a quaternary phosphonium, such as tetrabutylphosphonium chloride, serving as a catalyst for an esterification reaction at a reaction temperature of 80° C. to 130° C., particularly 100° C. to 120° C.

As the organic solvent used for the reaction, preferred are ketones, esters, amides, sulfoxides, ethers, and hydrocarbons. Specific examples thereof include acetone, methyl ethyl ketone, methyl isobutyl ketone, cyclohexanone, ethyl acetate, butyl acetate, propylene glycol monomethyl ether acetate, dimethylformamide, dimethylacetamide, N-methylpyrrolidone, dimethyl sulfoxide, diethyl ether, diisopropyl ether, tetrahydrofuran, dioxane, toluene, and xylene. These may be appropriately selected in view of their boiling points and compatibility.

The number-average molecular weight (Mn) of the compound (V) described in detail above is preferably in the range of 500 to 10,000, more preferably 1,000 to 6,000. Additionally, the weight-average molecular weight (Mw) is preferably in the range of 3,000 to 80,000, preferably 4,000 to 60,000. When Mn and Mw of the compound (V) are within these ranges, gelation can be prevented, and it is easy to form a cured coating film having a high degree of crosslinking and excellent smudge resistance. Mn and Mw are values measured on the basis of the above-described GPC measurement.

The compound (V) preferably has a fluorine atom content of 2% to 35% by mass in view of the smudge resistance of the cured film. The compound (V) preferably has a polymerizable unsaturated group content of 200 to 5,000 g/eq., particularly preferably 500 to 3,000 g/eq. in terms of the equivalent weight of the polymerizable unsaturated group from the viewpoint of achieving excellent scratch resistance of the cured film.

With respect to the compound (V) having the PFPE chain and the polymerizable unsaturated group, for example, when a compound having an adamantyl group disclosed in Japanese Unexamined Patent Application Publication No. 2012-92308 is used, the cured film can have higher surface hardness. Moreover, the compound (V) may also be a compound, which is disclosed in Japanese Unexamined Patent Application Publication No. 2011-74248, obtained by allowing a copolymer that has been produced by the copolymerization of, as essential monomer components, the compound (V-1) having the PFPE chain and the polymerizable unsaturated group at each end thereof and the polymerizable unsaturated monomer (V-2) having a reactive functional group (α) to react with a compound (V-3′) having the functional group (β) reactive with the functional group (α) and two or more polymerizable unsaturated groups.

The composition of the present invention can be irradiated with actinic energy rays, such as ultraviolet rays, to form a cured article. The shape of the cured article is not particularly limited. From the viewpoint of further enhancing the effects of the present invention, a film-shaped cured article is preferred. The composition is preferably used as an antireflective coating composition in view of a low refractive index and low reflectance.

In the case where the composition of the present invention is cured, a polymerization initiator is added. Examples of the polymerization initiator include benzophenone, acetophenone, benzoin, benzoin ethyl ether, benzoin isobutyl ether, benzyl methyl ketal, azobisisobutyronitrile, 1-hydroxycyclohexyl phenyl ketone, 2-hydroxy-2-methyl-1-phenyl-1-one, 1-(4′-isopropylphenyl)-2-hydroxy-2-methylpropan-1-one, 1-(4′-dodecylphenyl)-2-hydroxy-2-methylpropan-1-one, 3,3′,4,4′-tetra(tert-butylperoxycarbonyl)benzophenone, 4,4″-diethylisophthalophene, 2,2-dimethoxy-1,2-diphenylethan-1-one, benzoin isopropyl ether, thioxanthone, 2-chlorothioxanthone, 2-methylthioxanthone, 2-isopropylthioxanthone, 2-methyl-1[4-(methylthio)phenyl]-2-morpholinopropan-1-one, 2-benzyl-2-dimethylamino-1-(4-morpholinophenyl)-butanone-1, bis(2,6-dimethoxybenzoyl)-2,4,4-trimethyl-pentylphosphine oxide, bis(2,4,6,-trimethylbenzoyl)-phenylphosphine oxide, and 2,4,6-trimethylbenzoyldiphenylphosphine oxide. These may be used alone or in combination of two or more.

Moreover, a photosensitizer, such as an amine compound or a phosphorus compound, can be added to promote photopolymerization, as needed.

The amount of the polymerization initiator added is preferably in the range of 0.01 to 15 parts by mass, more preferably 0.3 to 7 parts by mass based on 100 parts by mass of the curable components (non-volatile components) in the composition.

The composition of the present invention can further contain additives, such as an organic solvent, a polymerization inhibitor, an antistatic agent, an antifoaming agent, a viscosity modifier, a light stabilizer, a heat stabilizer, and an antioxidant in accordance with the purpose, such as applications and characteristics to the extent that the effects of the present invention are not impaired.

To impart appropriate application properties to the composition of the present invention, the viscosity may be adjusted by the addition of an organic solvent. Examples of the organic solvent that can be used here include acetate solvents, such as propylene glycol monomethyl ether acetate, and propylene glycol monoethyl ether acetate; propionate solvents, such as ethoxy propionate; aromatic solvents, such as toluene, xylene, and methoxybenzene; ether solvents, such as butyl cellosolve, propylene glycol monomethyl ether, diethylene glycol ethyl ether, and diethylene glycol dimethyl ether; ketone solvents, such as methyl ethyl ketone, methyl isobutyl ketone, and cyclohexanone; aliphatic hydrocarbon solvents, such as hexane; nitrogen compound solvents, such as N,N-dimethylformamide, γ-butyrolactam, and N-methyl-2-pyrrolidone; lactone solvents, such as γ-butyrolactone; and carbamic ester. These solvents may be used alone or in combination of two or more.

The amount by mass of the organic solvent used varies in accordance with the application, target thickness, and target viscosity and is preferably in the range of 4 to 200 times the total amount of the curable components (non-volatile components) in the composition.

Examples of actinic energy rays for curing the composition of the present invention include actinic energy rays, such as light, electron beams, and radiation. Specific examples of an energy source or a curing device include ultraviolet rays emitted from light sources, such as germicidal lamps, fluorescent lamps for ultraviolet rays, carbon arcs, xenon lamps, high-pressure mercury lamps for coping, medium-pressure or high-pressure mercury lamps, ultrahigh pressure mercury lamps, electrodeless lamps, metal halide lamps, and natural light, and electron beams emitted from scan- or curtain-type electron beam accelerators. When curing is performed by electron beams, the polymerization initiator need not be added.

Among these actinic energy rays, in particular, ultraviolet rays are preferred. Irradiation in an inert gas atmosphere, such as nitrogen gas, is preferred because the surface curability of a coating film is improved. Additionally, heat may be used as an energy source, if necessary. That is, curing with the active energy rays is performed, and then heat treatment may be performed.

Examples of a method for applying the composition of the present invention include application methods using, for example, a gravure coater, a roll coater, a comma coater, a knife coater, a curtain coater, a shower coater, a spin coater, a slit coater, dipping, screen printing, spraying, an applicator, or a bar coater.

An antireflection film of the present invention includes a cured film of the composition of the present invention and can be produced by a specific method below. (1) A hard coating material is applied to a substrate and cured to form a coating film serving as a hard coating layer. (2) The composition of the present invention is applied to the hard coating layer and cured to form a coating film serving as a low-refractive-index layer. The low-refractive-index layer serves as the outermost surface of the antireflection film.

An intermediate-refractive-index layer and/or a high-refractive-index layer may be disposed between the hard coating layer and the low-refractive-index layer.

Any hard coating material can be used as long as it enables formation of a cured coating film having a relatively high surface hardness. Preferred is a combination of the actinic energy ray-curable monomer (III-1) and the actinic energy ray-curable resin (III-2), which have been exemplified as the actinic energy ray-curable compound (III).

The thickness of the hard coating layer is preferably in the range of 0.1 to 100 μm, more preferably 1 to 30 μm, even more preferably 3 to 15 μm. The hard coating layer having a thickness within the range has an enhanced adhesion to the substrate and enables an improvement in the surface hardness of the antireflection film. The hard coating layer may have any refractive index. A high refractive index of the hard coating layer results in a good antireflection effect without providing the above-mentioned intermediate-refractive-index layer or high-refractive-index layer.

The thickness of the low-refractive-index layer formed by applying and curing the composition of the present invention is preferably in the range of 50 to 300 nm, more preferably 50 to 150 nm, even more preferably 80 to 120 nm. The low-refractive-index layer having a thickness within the above range can improve an antireflection effect. The refractive index of the low-refractive-index layer is preferably in the range of 1.20 to 1.45, more preferably 1.23 to 1.42. The low-refractive-index layer having a refractive index within the above range can improve the antireflection effect.

The thickness of the intermediate-refractive-index layer or high-refractive-index layer is preferably in the range of 10 to 300 nm, more preferably 30 to 200 nm. The refractive index of the intermediate-refractive-index layer or high-refractive-index layer is selected on the basis of the refractive indices of the overlying low-refractive-index layer and the underlying hard coating layer and can be appropriately set to a value in the range of 1.40 to 2.00. [0156]

Examples of materials for forming the intermediate-refractive-index layer or the high-refractive-index layer include heat-curable, UV-curable, and electron beam-curable resins, such as epoxy resins, phenolic resins, melamine resins, alkyd resins, cyanate resins, acrylic resins, polyester resins, urethane resins, and siloxane resins. These may be used alone or in combination of two or more. These resins are preferably mixed with fine inorganic particles having a high refractive index.

The fine inorganic particles having a high refractive index preferably have a refractive index of 1.65 to 2.00. Examples thereof include zinc oxide having a refractive index of 1.90, titania having a refractive index of 2.3 to 2.7, ceria having a refractive index of 1.95, tin-doped indium oxide having a refractive index of 1.95 to 2.00, antimony-doped tin oxide having a refractive index of 1.75 to 1.85, yttria having a refractive index of 1.87, and zirconia having a refractive index of 2.10. These fine inorganic particles having a high refractive index may be used alone or in combination of two or more.

In the case where the intermediate-refractive-index layer or high-refractive-index layer is formed in the same manner as for the composition of the present invention, the productivity can be improved. Thus, in the case where the composition of the present invention is cured with ultraviolet rays, the intermediate-refractive-index layer or high-refractive-index layer is preferably formed from a UV-curable composition.

Examples of the substrate used for forming the antireflection film of the present invention include films composed of polyesters, such as poly(ethylene terephthalate), poly(butylene terephthalate), and poly(ethylene naphthalate); films composed of polyolefins, such as polypropylene, polyethylene, polymethylpentene-1; films composed of cellulose, such as triacetyl cellulose (TAC); and polystyrene films, polyamide films, polycarbonate films, norbornene resin films (for example, “Zeonor”, available from Zeon Corporation), modified norbornene resin films (for example, “Arton”, available from JSR Corporation), cyclic olefin copolymer films (for example, “Apel”, available from Mitsui Chemicals, Inc.), and films composed of acrylic compounds, such as poly(methyl methacrylate) (PMMA). Two or more of these films may be bonded to each other and used. Each of the films may be in the form of a sheet. The film substrate preferably has a thickness of 20 to 500 μm.

The antireflection film of the present invention preferably has a reflectance of 2.0% or less, more preferably 1.5% or less, even more preferably 1.0% or less.

### EXAMPLES

While the present invention will be described in more detail by examples, the present invention is not limited to these examples.

### Synthesis Example 1

Into a glass flask equipped with a stirrer, a thermometer, a condenser, and a dropping device, 100 g of 1,3-bis(trifluoromethyl)benzene, 100 g of a poly(perfluoroalkylene ether) compound having a hydroxy group at each end thereof, represented by a structural formula given below, 0.05 g of p-methoxyphenol, 0.38 g of dibutylhydroxytoluene, and 0.04 g of tin octanoate were charged. The stirring of the mixture was started under an air stream. Then 25.98 g of 1,1-(bisacryloyloxymethyl)ethyl isocyanate was added dropwise thereto over a period of 1 hour while the mixture was maintained at 75° C. After the completion of the dropwise addition, the mixture was stirred at 75° C. for 1 hour. The temperature was increased to 80° C. The mixture was stirred for 10 hours. The disappearance of the isocyanate group was confirmed by IR spectrum measurement.

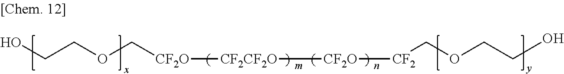

(In the formula, x+y≈1, and in one molecule, eight perfluoroethylene groups (m) on average and seven perfluoromethylene groups (n) on average were present, and the number of fluorine atoms was 46 on average).

The organic solvent was removed by evaporation under reduced pressure to give a 30% by mass solution of a compound (I-1), represented by a structural formula given below, in methyl isobutyl ketone.

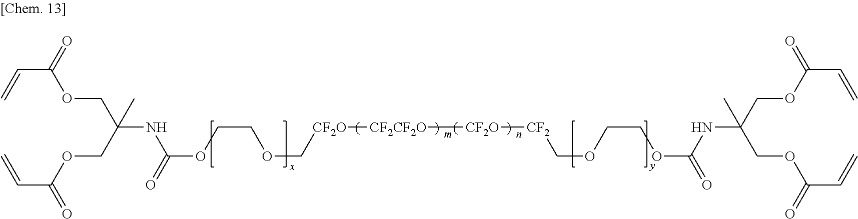

### Synthesis Example 2

Into a glass flask equipped with a stirrer, a thermometer, a condenser, and a dropping device, 150 parts by mass of a perfluoropolyether compound having a hydroxy group at each end thereof, represented by a structural formula given below, 68 parts by mass of p-chloromethylstyrene, 0.05 parts by mass of p-methoxyphenol, 44 parts by mass of a 50% by mass aqueous solution of benzyltriethylammonium chloride, and 0.12 parts by mass of potassium iodide were charged. The stirring of the mixture was started under an air stream. The temperature in the flask was increased to 45° C. Then 1.3 parts by mass of a 49% by mass aqueous solution of sodium hydroxide was added dropwise over a period of 2 hours. After the completion of the dropwise addition, the temperature was increased to 60° C. The mixture was stirred for 1 hour. Then 11.5 parts by mass of a 49% by mass aqueous solution of sodium hydroxide was added dropwise over a period of 4 hours, and then the reaction was performed for another 15 hours.

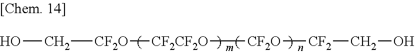

(In the formula, in one molecule, 19 perfluoroethylene groups (m) on average and 19 perfluoromethylene groups (n) on average were present, and the number of fluorine atoms was 114 on average).

After the completion of the reaction, the salt formed was filtered. The filtrate was allowed to stand, and the supernatant was removed. The resulting liquid was washed with 500 mL of water three times. After washing with water, the liquid was further washed with 500 mL of methanol three times. Next, 0.06 parts by mass of p-methoxyphenol serving as a polymerization inhibitor and 0.2 parts by mass of 3,5-tert-dibutyl-4-hydroxytoluene (hereinafter, abbreviated as “BHT”) were added to the resulting liquid. Methanol was removed by evaporation with a rotary evaporator and a water bath set at 45° C. while concentration was performed, thereby producing a compound having a poly(perfluoroalkylene ether) chain and a styryl group at each end thereof, represented by a structural formula given below.

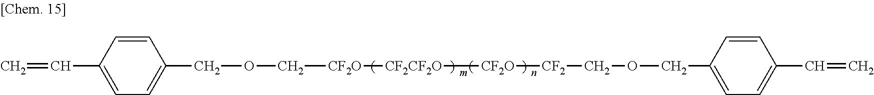

Into a glass flask equipped with a stirrer, a thermometer, a condenser, and a dropping device, 73.1 parts by mass of 1,3-bis(trifluoromethyl)benzene serving as a solvent was charged. The temperature was increased to 105° C. while the mixture was stirred under a nitrogen stream. Three types of dropping liquids, i.e., 41.8 parts by mass of the compound having the poly(perfluoroalkylene ether) chain and the styryl group at each end thereof, 80 parts by mass of 2-hydroxyethyl methacrylate, and a polymerization initiator solution prepared by dissolving 18.3 parts by mass of tert-butyl peroxy-2-ethylhexanoate serving as a radical polymerization initiator in 153.1 parts by mass of 1,3-bis(trifluoromethyl)benzene, were separately charged into respective dropping devices and added dropwise at the same time over a period of 2 hours while the temperature in the flask was maintained at 105° C. After the completion of the dropwise addition, the mixture was stirred at 105° C. for 10 hours to prepare a polymer solution.

To the resulting polymer solution, 0.08 parts by mass of p-methoxyphenol serving as a polymerization inhibitor and 0.06 parts by mass of tin octanoate serving as a catalyst for urethane formation were added. The stirring of the mixture was started under an air stream. Then 85 parts by mass of 2-acryloyloxyethyl isocyanate was added dropwise thereto over a period of 1 hour while the mixture was maintained at 60° C. After the completion of the dropwise addition, the mixture was stirred at 60° C. for 1 hour. The temperature was increased to 80° C. The reaction was performed under stirring for 5 hours. The disappearance of the peak of the isocyanate group was confirmed by IR spectrum measurement.

The solid formed in the reaction mixture was removed by filtration. The solvent was partially removed by evaporation under reduced pressure to prepare a 50% by mass solution of a compound (I-2) in 1,3-bis(trifluoromethyl)benzene. The compound (I-2) had a weight-average molecular weight of 3,300.

### Synthesis Example 3

Into a glass flask equipped with a stirrer, a thermometer, and a condenser, 26.4 g of isopropyl ether serving as a solvent, 25.2 g of a silicone compound having a hydroxy group at one end thereof represented by a formula given below (where n was about 65), and 0.66 g of triethylamine serving as a catalyst were charged. The mixture was stirred for 30 minutes while the temperature in the flask was maintained at 5° C.

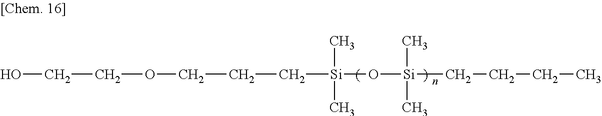

Then 1.50 g of 2-bromoisobutyryl bromide was added thereto. The mixture was stirred for 3 hours. The temperature was increased to 40° C. The mixture was stirred for 8 hours. After the completion of the reaction, the mixture was washed three times by a method in which 80 g of ion-exchanged water was added to the mixture, the resulting mixture was stirred and allowed to stand to separate the aqueous layer, and the aqueous layer was removed. Then 8 g of magnesium sulfate serving as a dehydrating agent was added. The organic layer was allowed to stand for 1 day and thus completely dehydrated. The dehydrating agent was removed by filtration. The solvent was then removed by evaporation under reduced pressure to give a compound containing a functional group having an ability to generate a radical and one silicone chain having a molecular weight of 2,000 or more represented by a formula given below.

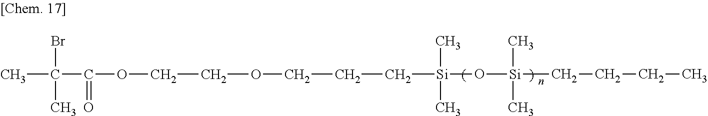

A glass flask equipped with a nitrogen inlet, a stirrer, a thermometer, and a condenser was purged with nitrogen. Then 30.70 g of isopropyl alcohol, 30.70 g of methyl ethyl ketone, 10.93 g of tridecafluorohexylethyl methacrylate, and 0.5470 g of methoxybenzene were charged thereinto. The mixture was stirred at 25° C. for 1 hour under a nitrogen stream. To the mixture, 0.4510 g of copper(I) chloride, 0.1130 g of copper(II) bromide, and 1.581 g of 2,2-bipyridyl were added. The mixture was stirred for 30 minutes. The temperature was increased to 60° C., and then 30 g of the compound containing a functional group having an ability to generate a radical and one silicone chain having a molecular weight of 2,000 or more was added thereto. The mixture was stirred for 4 hours while the temperature in the flask was maintained at 60° C. Then 6.585 g of 2-hydroxyethyl methacrylate was added thereto. The mixture was stirred for 1 hour. The temperature was increased to 75° C., and the mixture was stirred for 31 hours. In air, 1.167 g of an 85% aqueous solution of phosphoric acid was added thereto. The mixture was stirred for 2 hours. The precipitated solid was separated by filtration. The catalyst was removed with an ion-exchange resin. The ion-exchange resin was removed by filtration to give a block copolymer. Next, 32.54 g of the resulting copolymer, 36.70 g of methyl isobutyl ketone, 0.0149 parts by mass of p-methoxyphenol serving as a polymerization inhibitor, 0.1116 g of dibutylhydroxytoluene, and 0.0111 g of tin octanoate serving as a catalyst for urethane formation were charged into a glass flask equipped with a nitrogen inlet, a stirrer, a thermometer, a condenser, and a dropping device. The stirring was started under an air stream. Then 4.67 g of 2-acryloyloxyethyl isocyanate was added thereto while the mixture was maintained at 60° C. The mixture was stirred at 60° C. for 1 hour. The temperature was increased to 80° C., and the mixture was stirred for 4 hours. The disappearance of the isocyanate group was confirmed by IR spectrum measurement. Then 50.46 g of methyl isobutyl ketone was added to prepare a 30% by mass solution of an actinic energy ray-curable group-containing fluorinated compound (II) in methyl isobutyl ketone. The molecular weight of the resulting compound (II) was measured by GPC (molecular weight in terms of polystyrene), and the compound had a number-average molecular weight of 10,500 and a weight-average molecular weight of 12,000.

### Examples 1 to 14 and Comparative Examples 1 to 3

The mixtures of the compound (I) (the compound (I-1) or compound (I-2)) and the compound (II) given in tables were evaluated as described below. Tables 1 to 3 present the results.

### <Measurement of Refractive Index>

The refractive indices of the mixtures of the compound

(I) and the compound (II) were measured with an Abbe refractometer available from Atago Co., Ltd. at 25° C. and 589 nm. The mixing ratios were the same as the proportions of (I) and (II) in antireflective coating compositions prepared as described below.

### <Preparation of Antireflective Coating Composition>

A dispersion containing 20% by mass fine hollow silica particles (average particle size: 60 nm), pentaerythritol triacrylate (PETA), 2-hydroxy-1-{4-[4-(2-hydroxy-2-methyl-propionyl)-benzyl]-phenyl}-2-methyl-propan-1-one (“Irgacure 127”, available from Ciba Japan K.K.) serving as a photoinitiator, and the compounds synthesized as described above were mixed in proportions given in the tables. Methyl isobutyl ketone serving as a solvent was added thereto, thereby preparing a composition with a non-volatile content adjusted to 5%.

### <Formulation of Coating Composition for Hard Coating Layer>

Thirty parts by mass of urethane acrylate (“UV1700B”, Nippon Synthetic Chemical Industry Co., Ltd.), 25 parts by mass of butyl acetate, 1.2 parts by mass of 1-hydroxycyclohexyl phenyl ketone (“Irgacure 184”, available from Ciba Specialty Chemicals) serving as a photoinitiator, 11.78 parts by mass of toluene, 5.892 parts by mass of 2-propanol, 5.892 parts by mass of ethyl acetate, and 5.892 parts by mass of propylene glycol monomethyl ether serving as solvents were mixed and dissolved to prepare a coating composition for a hard coating layer.

### <Production of Antireflection Film>

The resulting coating composition for a hard coating layer was applied to a PET film having a thickness of 188 μm with a No. 13 bar coater, placed in a dryer to evaporate the solvents at 70° C. for 1 minute, and cured with an ultraviolet curing device (in a nitrogen atmosphere, with a high-pressure mercury lamp, at an amount of UV irradiation of 0.5 kJ/m²) to produce a hard-coated film having an 8-μm-thick hard coating layer on one side.

The antireflective coating composition was applied onto the hard coating layer of the hard-coated film produced as described above with a No. 2 bar coater, placed in a dryer to evaporate the solvent at 50° C. for 1 minute 30 seconds, and cured with an ultraviolet curing device (in a nitrogen atmosphere, with a high-pressure mercury lamp, at an amount of UV irradiation of 2 kJ/m²) to produce a film (antireflection film) having the 10-μm-thick hard coating layer and a 0.1-μm-thick antireflection layer on the hard coating layer. The appearance of the surface of the cured film of the resulting film was visually observed and evaluated as described below. The results are presented in the tables.

### <Measurement of Reflectance>

A spectrophotometer (“U-4100”, available from Hitachi High-Tech Corporation) having a five-degree specular-reflection-measuring device was used to measure reflectance. The minimum value (lowest reflectance) at a wavelength of about 550 nm was defined as the reflectance.

### <Evaluation of Scratch Resistance>

No. 0000 steel wool was attached to an indenter measuring 1 cm×1 cm of a TYPE:38 TriboGear surface property tester, available from Shinto Scientific Co., Ltd., and subjected to 10 reciprocating cycles at a load of 700 g. The number of scratches on the surface of the cured film was counted after the test. The scratch resistance was evaluated according to the following criteria.

└: No scratches can be visually observed.

◯: The number of scratches is less than three.

Δ: The number of scratches is 4 or more and less than 10.

X: The number of scratches is 10 or more.

TABLE 1

| | | Example | Example | Example | Example | Example | Example | Example |
|---|---|---|---|---|---|---|---|---|
| | | 1 | 2 | 3 | 4 | 5 | 6 | 7 |
| Polyfunctional | Compound | 32.4 | 15.0 | 18.3 | 2.2 | 20.3 | 9.4 | 13.7 |
| compound (I) | (I-1) | | | | | | | |
| | Compound | | | | | | | |
| | (I-2) | | | | | | | |

| | | | | | | | |
|---|---|---|---|---|---|---|---|
| Compound (II) | 6.6 | 3.0 | 3.7 | 0.5 | 15.2 | 7.0 | 10.3 |
| Refractive index of mixture | 1.38 | 1.38 | 1.38 | 1.38 | 1.39 | 1.39 | 1.39 |
| of compound (I) and | | | | | | | |
| compound (II) | | | | | | | |
| Fine hollow silica particles | 31.0 | 42.0 | 40.0 | 50.0 | 34.5 | 43.6 | 40.0 |
| PETA | 30.0 | 40.0 | 38.0 | 47.3 | 30.0 | 40.0 | 36.0 |
| Photoinitiator | 2.0 | 2.0 | 2.0 | 2.0 | 2.0 | 2.0 | 2.0 |
| Appearance | good | good | good | good | good | good | good |
| Reflectance | 1% | 1% | 1% | 1% | 1% | 1% | 1% |
| Scratch resistance | ⊚ | ⊚ | ⊚ | ◯ | ⊚ | ⊚ | ⊚ |

TABLE 2

| | | Example | Example | Example | Example | Example | Example | Example |
|---|---|---|---|---|---|---|---|---|
| | | 8 | 9 | 10 | 11 | 12 | 13 | 14 |
| Polyfunctional | Compound | 1.7 | 12.5 | 5.8 | 10.3 | 1.3 | | |
| compound (I) | (I-1) | | | | | | | |
| | Compound | | | | | | 11.0 | 24.0 |
| | (I-2) | | | | | | | |

| | | | | | | | |
|---|---|---|---|---|---|---|---|
| Compound (II) | 1.3 | 20.0 | 9.2 | 16.4 | 2.0 | 4.0 | 3.5 |
| Refractive index of mixture | 1.39 | 1.40 | 1.40 | 1.40 | 1.40 | 1.40 | 1.40 |
| of compound (I) and | | | | | | | |
| compound (II) | | | | | | | |
| Fine hollow silica particles | 50.0 | 37.5 | 45.0 | 40.0 | 50.0 | 50.0 | 40.0 |
| PETA | 47.0 | 30.0 | 40.0 | 33.3 | 46.7 | 39.0 | 36.0 |
| Photoinitiator | 2.0 | 2.0 | 2.0 | 2.0 | 2.0 | 2.0 | 2.0 |
| Appearance | good | good | good | good | good | good | good |
| Reflectance | 1% | 1% | 1% | 1% | 1% | 1% | 1% |
| Scratch resistance | ◯ | ⊚ | ⊚ | ⊚ | ◯ | ⊚ | ⊚ |

TABLE 3

| | | |
|---|---|---|
| Comparative | Comparative | Comparative |
| example 1 | example 2 | example 3 |

| | | | |
|---|---|---|---|
| Polyfunctional | Compound | 17 | |
| compound (I) | (I-1) | | |
| | Compound | | 24 |
| | (I-2) | | |

| | | | |
|---|---|---|---|
| Compound (II) | 34 | | |
| Refractive index of mixture | 1.42 | 1.37 | 1.40 |
| of compound (I) and | | | |
| compound (II) | | | |
| Fine hollow silica particles | 40 | 40 | 40 |
| PETA | 26 | 43 | 36 |
| Photoinitiator | 2.0 | 2.0 | 2.0 |
| Appearance | nonuniform | good | good |
| Reflectance | unmeasurable | 1% | 1% |
| Scratch resistance | unevaluable | x | x |

1. An actinic energy ray-curable composition, comprising:
a poly(perfluoroalkylene ether) chain-containing actinic energy ray-curable polyfunctional compound (I); and
an actinic energy ray-curable compound (II) that is a copolymer of polymerizable unsaturated monomers, the actinic energy ray-curable compound (II) having a side chain containing a fluorinated alkyl group (x) having 1 to 6 carbon atoms to which a fluorine atom is attached and a side chain containing an actinic energy ray-curable group (y), the actinic energy ray-curable compound (II) having a silicone chain (z) with a molecular weight of 2,000 or more at one end of the copolymer.

2. The actinic energy ray-curable composition according to claim 1, further comprising an actinic energy ray-curable compound (III) other than the actinic energy ray-curable polyfunctional compound (I) or the actinic energy ray-curable compound (II).

3. The actinic energy ray-curable composition according to claim 1, further comprising a refractive index-lowering agent (IV).

4. The actinic energy ray-curable composition according to claim 3, wherein the refractive index-lowering agent (IV) is fine hollow silica particles.

5. The actinic energy ray-curable composition according to claim 1, wherein the poly(perfluoroalkylene ether) chain-containing actinic energy ray-curable polyfunctional compound (I) is a compound having one or more (meth)acryloyl groups at each end of a molecular chain containing the poly(perfluoroalkylene ether) chain.

6. The actinic energy ray-curable composition according to claim 1, wherein the poly(perfluoroalkylene ether) chain-containing actinic energy ray-curable polyfunctional compound (I) is a compound having two or more (meth)acryloyl groups at each end of a molecular chain containing the poly(perfluoroalkylene ether) chain via a urethane linkage.

7. The actinic energy ray-curable composition according to claim 1, wherein the poly(perfluoroalkylene ether) chain-containing actinic energy ray-curable polyfunctional compound (I) is a compound having a (meth)acryloyl group at each end of a molecular chain containing the poly(perfluoroalkylene ether) chain via a structure originating from styrene.

8. The actinic energy ray-curable composition according to claim 1, wherein the silicone chain (z) in the actinic energy ray-curable compound (II) has a molecular weight of 2,000 to 20,000.

9. The actinic energy ray-curable composition according to claim 1, wherein the actinic energy ray-curable group of the actinic energy ray-curable compound (II) has an equivalent weight of 200 to 3,500 g/eq.

10. The actinic energy ray-curable composition according to claim 1, wherein the actinic energy ray-curable compound (II) has a number-average molecular weight of 3,000 to 100,000, and a ratio of a weight-average molecular weight to the number-average molecular weight, i.e., a polydispersity index (Mw/Mn), is in a range of 1.0 to 1.4.

11. The actinic energy ray-curable composition according to claim 1, wherein a usage ratio (by mass) of the poly(perfluoroalkylene ether) chain-containing actinic energy ray-curable polyfunctional compound (I) to the actinic energy ray-curable compound (II) that is a copolymer of polymerizable unsaturated monomers, i.e., (I)/(II), is in a range of 90/10 to 30/70, the actinic energy ray-curable compound (II) having a side chain containing a fluorinated alkyl group (x) having 1 to 6 carbon atoms to which a fluorine atom is attached and a side chain containing an actinic energy ray-curable group (y), the actinic energy ray-curable compound (II) having a silicone chain (z) with a molecular weight of 2,000 or more at one end of the copolymer.

12. The actinic energy ray-curable composition according to claim 1, wherein the actinic energy ray-curable composition is an antireflective coating composition.

13. A cured film of the actinic energy ray-curable composition according to claim 1.

14. An antireflection film, comprising a cured film of the actinic energy ray-curable composition according to claim 1.

15. The antireflection film according to claim 14, wherein the cured film has a thickness of 50 to 300 nm.

16. The actinic energy ray-curable composition according to claim 2, further comprising a refractive index-lowering agent (IV).

17. The actinic energy ray-curable composition according to claim 2, wherein the poly(perfluoroalkylene ether) chain-containing actinic energy ray-curable polyfunctional compound (I) is a compound having one or more (meth)acryloyl groups at each end of a molecular chain containing the poly(perfluoroalkylene ether) chain.

18. The actinic energy ray-curable composition according to claim 2, wherein the poly(perfluoroalkylene ether) chain-containing actinic energy ray-curable polyfunctional compound (I) is a compound having two or more (meth)acryloyl groups at each end of a molecular chain containing the poly(perfluoroalkylene ether) chain via a urethane linkage.

19. The actinic energy ray-curable composition according to claim 2, wherein the poly(perfluoroalkylene ether) chain-containing actinic energy ray-curable polyfunctional compound (I) is a compound having a (meth)acryloyl group at each end of a molecular chain containing the poly(perfluoroalkylene ether) chain via a structure originating from styrene.

20. The actinic energy ray-curable composition according to claim 2, wherein the silicone chain (z) in the actinic energy ray-curable compound (II) has a molecular weight of 2,000 to 20,000.
